SEQUENCE LISTING (1 sequence)

SEQ ID NO: 1 - protein, 393 aa, synthetic construct [sequence omitted]

(19) United States
(12) Patent Application Publication
(10) Pub. No.: US 2023/0108717 A1
(43) Pub. Date: Apr. 6, 2023

(54) NOVEL METHODS OF CREATING A PROTEIN MAP AND USING SAID MAP TO IDENTIFY THERAPEUTIC TARGETS

(71) Applicant: The Penn State Research Foundation, University Park, PA (US)

(72) Inventor: Deborah F. Kelly, University Park, PA (US)

(21) Appl. No.: 17/938,136

(22) Filed: Oct. 5, 2022

Related U.S. Application Data
(60) Provisional application No. 63/252,362, filed on Oct. 5, 2021.

(51) Int. Cl. G02B 21/36; G01N 21/64

(52) U.S. Cl. CPC G02B 21/367; G01N 21/6456

(57) ABSTRACT

Disclosed are novel methods for imaging a protein structure via cryo-electron microscopy and methods of using said protein structure images to identify novel therapeutic targets in a protein.

### I. CROSS REFERENCE TO RELATED APPLICATIONS

This application claims the benefit of U.S. Provisional Patent Application Ser. No. 63/252,362 filed Oct. 5, 2021, which is expressly incorporated herein by reference in its entirety.

### II. STATEMENT REGARDING FEDERALLY SPONSORED RESEARCH OR DEVELOPMENT

This invention was made with government support under Grant Nos. CA193578, CA227261, and CA219700 awarded by the National Institutes of Health. The government has certain rights in the invention.

### III. REFERENCE TO A SEQUENCE LISTING

The Sequence Listing submitted on Oct. 5, 2022 as an XML filed named “11196-067US1_Sequence.xml,” created on Oct. 4, 2022, and having a size of 4,096 bytes is hereby incorporated by reference pursuant to 37 C.F.R. § 1.834.

### IV. BACKGROUND

It has been 40 years since the discovery of the tumor suppressor protein, p53, often referred to as the “guardian of the genome”. The multi-faceted roles of p53 range from cell cycle arrest to DNA repair and apoptosis. Unfortunately, as these essential duties become deregulated at the molecular level, disease develops in vulnerable cells and tissues. In fact, errors in p53 function are implicated in approximately half of all human cancers. Curiously, the full three-dimensional (3D) structure of p53 remains a mystery. This lack of knowledge presents barriers to understanding the molecular properties of p53 for rational drug design and other pharmacological applications. What are needed are new methods to elucidate the 3D structure of proteins and identify new targets for therapeutics in the treatment of diseases such as cancer.

### V. SUMMARY

Disclosed are methods related to novel methods of using cryo-electron microscopy to create a protein map and using said methods to identify novel therapeutic targets on said protein.

In one aspect, disclosed herein are methods of resolving full-length protein structure, said method comprising isolating the protein of interest, applying the protein to a microchip with or without functionalized coatings, and creating an electron microscopy (EM) map (such as, for example, by calculating multimeric structures and modeling the molecular structure of the protein; constructing a full-length protein model using protein prediction software and fitting the structure into an EM map using rigid-body refinement), optionally along with complementary biochemical on-chip testing assays for downstream characterization. Such downstream characterization steps may include Mass Spectrometry analysis, SDS-PAGE analysis, Surface Plasmon Resonance analysis, Enzyme-linked immunoassays, lateral-flow cassette analysis, on-chip microfluidic analysis, Atomic force microscopy, Scanning Transmission EM (STEM), and chemical mapping analysis. In some aspects, the protein structure is resolved in a liquid solution. Viewing biological samples in a dynamic, liquid setting can significantly expand structural observations. It is highly desirable to pair high-resolution information with real-time dynamics to better interpret biological events in rapid timeframes—the order of milliseconds or faster. Such rapid events may include changes in pliable proteins loops that serve as ubiquitination sites on tumor suppressor. Improved knowledge of these flexible structures may impact the design of antibody therapies or even anti-viral reagents to combat SARS-CoV-2 infection. Importantly, viewing biological materials in a fluid, stochastic environment provides unique insight of their performance in the human body.

Also disclosed herein are method of resolving a full-length protein structure of any preceding aspect, wherein the microchip comprises flat surfaces or microwells are coated with nickel-nitrilotriacetic (Ni-NTA) and/or comprises microwells that are 100 nm-200 nm in size. In some aspects, the microchip can further comprise a carbon grid.

In one aspect, disclosed herein are methods of identifying a therapeutic target, said method comprising isolating a protein of interest, applying the protein to a microchip, and creating an electron microscopy (EM) map; wherein the EM map is created by calculating multimeric (e.g., dimeric) structures of the protein and modeling the molecular structure of the protein; constructing a full-length protein model using a protein prediction software and fitting the full-length protein model into an EM map using rigid-body refinement; and assaying individual residues in a DNA-bound model for mutations at residues that do not directly interact with the helical backbone, mutations that effect post translational modification sites, and/or mutations at residues that contact the helical backbone; wherein an identified mutation comprises a therapeutic target.

### VI. BRIEF DESCRIPTION OF THE DRAWINGS

The accompanying drawings, which are incorporated in and constitute a part of this specification, illustrate several embodiments and together with the description illustrate the disclosed compositions and methods.

FIG. 1. Strategy to isolate native p53 from cancer cells for EM imaging analysis. Cancer cells were cultured under normal growth conditions (Step 1). P53 assemblies were biochemically isolated and the presence of dimers (˜100 kDa) were confirmed using SDS-PAGE and western blots (IB). Primary antibodies were against the p53 NTD (Step 2). Aliquots of p53 were applied to microchips that were flash-frozen into liquid ethane (Step 3). An expanded side view of the microchips shows the 10-micron sized microwells that accommodate a solution of ˜150 nm. Frozen samples can be examined using a variety of electron microscopes (Step 4).

FIG. 2A, FIG. 2B, FIG. 2C, FIG. 2D, and FIG. 2E show that full-length p53 dimers form a stable “inactive state” in the absence of DNA. FIG. 2A shows schematic for the p53 primary structure (residues 1-392) highlighting the NTD, DBD, and CTD along with regions of known phosphorylation or ubiquitination sites and hot spot mutations. FIG. 2A shows rotational views of the p53 dimer lacking DNA. Two p53 monomers (green and cyan) were fit into the EM density map. Close-up view of a helix in the DBD shows some side-chains ranging from R280-R290. FIG. 2C shows cryo-EM image and class averages of the p53 dimers were not limited in particle orientations according to their angular distribution plot (2D). Scale bar is 20 nm. Box size is 10 nm. FIG. 2E shows the fourier shell correlation (FSC) curve and Cref (0.5) evaluation show a resolution of 4.2 A at the 0.143 value using the gold-standard (GS) criteria.

FIG. 3A, FIG. 3B, and FIG. 3C show biochemical characterization of p53 monomers. (FIG. 3A) P53 monomers enriched in alternative fractions migrated at 50 kDa according to SDS-PAGE and western blots. IB: immunoblot; primary antibodies were against the NTD of p53. (FIG. 3B) EM image of p53 monomer fractions. Scale bar is 20 nm. (FIG. 3C) Representative class averages of the p53 monomer. Box size is 15 nm. Adapted from Solares et al, 2020.

FIG. 4A, 4B, 4C, and 4D show Cryo-EM structure of the p53 monomer (FIG. 4A) EM structure shown in different rotational and cross-sectional views (FIG. 4B). The molecular model was developed using the PHYRE 2.0 software package and fit into the map using rigid body refinement protocols. Scale bar is 10 nm. (FIG. 4C) The Fourier shell correlation (FSC) curve and Cref (0.5) evaluation indicate a resolution of 5 Å at the 0.143 value using the gold-standard (GS) criteria. (FIG. 4D) Simply-blue stained denaturing gels showed the presence of p53 monomer (˜50 kDa) and dimer bands (˜100 kDa).

FIG. 5A and FIG. 5B show inactive p53 dimers are held in place by residues in the DBD. FIG. 5A show the p53 dimer interface (space-filled rendering) revealed key residues in the DBD domain that contributed to its structural stability. The NTD, DBD, and CTD are shown for dimer constituents that form an overall “crossed” architecture. FIG. 5B shows magnified view of the dimer interface shows the spatial relationship between residues. Amino acids in the interface site (purple and red) are listed along with additional residues that are considered mutational hot spots of cancer-relevance. (*) indicates residues that can be modified by ubiquitination, acetylation (K120 and K292) or by phosphorylation (T284). These modifications can help to modulate the dimer activation state.

FIG. 6A, FIG. 6B, and FIG. 6C show active p53 dimers bind to DNA and are subject to cancer-related mutations or hot spot modifications. FIG. 6A shows model (space-filled rending) of the p53 dimer (cyan, green) engaging DNA (yellow). The new model was produced based on the crystal structure of the DBDs bound to DNA (pdb code 2AC0). The dimer must transition from the inactive (crossed) configuration to an active parallel configuration to interact with DNA. A magnified view of the interface highlights residues (purple, red) involved in DNA engagement. (*) indicates residues that are subject to PTMs. FIG. 6B shows alternative view of the DNA-bound p53 dimer assembly. FIG. 6C shows mutations in the DBD were classified based on their spatial positions and potential effects on protein integrity, PTM hot spots including ubiquitination (Ub) and phosphorylation (P), or direct DNA interactions.

FIG. 7 shows proposed model for conformational changes in p53 dimers to go from an inactive state to an active DNA-binding state. The path toward activation may involve four phases: 1) inactivation; 2) rotation; 3) reposition; 4) activation. p53 monomers are in the crossed conformation during inactivation. One monomer moves towards a parallel configuration during rotation. The rotated monomer is then repositioned for DNA binding. Finally, activation occurs when both monomers assume a parallel configuration to interact with DNA.

FIG. 8A, FIG. 8B, and FIG. 8C show schematic representation of the microchip sandwich technique.

FIG. 9A, FIG. 9B, FIG. 9C, FIG. 9D, and FIG. 9E show that native p53 assemblies were isolated from human cancer cells and prepared for EM imaging using functionalized microchips. (FIG. 9A) Human cancer cells (U87 MG line) that produce wild type p53 were cultured under normal growth conditions. (FIG. 9B) P53 assemblies were biochemically isolated and stable dimers (˜100 kDa) were confirmed using SDS-PAGE and western blots (IB). Primary antibodies targeted the p53 NTD. (FIG. 9C) Aliquots of p53 were applied to functionalized microchips for imaging analysis. The schematic shows the central region of a microchip containing integrated microwells. The frames of the microchips are 2 mm×2 mm in x- and y- and 0.3 mm in z. Arrays of imaging windows are 500 μm in length and range from 100-200 μm in width. An expanded side view of a microchip array (black dashed rectangle) highlights the microwells that are 10 μm×10 μm in x- and y- and accommodate ˜150 nm in the z dimension. The path of the electron beam through the frozen-hydrated sample (blue cartoon) is also highlighted. (FIG. 9D) A micrograph of an imaging window containing integrated microwells is shown in comparison to integrated flow channels. Both microchip designs provided large usable regions of vitreous ice containing p53 particles. The reservoir width of the flow channels is 50 μm while the channel width is 10 μm. (FIG. 9E) Cryo-EM images of p53 dimers were obtained using a Talos F200C transmission electron microscope (TEM). Class averages of the dimers show different orientations. Scale bar is 20 nm. Box size is 10 nm.

FIG. 10A, FIG. 10B, FIG. 10C, and FIG. 10D show that full-length p53 dimers form a stable “inactive state” in the absence of DNA. (FIG. 10A) Schematic for the p53 primary structure (residues 1-393) highlighting the NTD, DBD, and CTD along with regions of known phosphorylation or ubiquitination sites and hot spot mutations. (FIG. 10B) Rotational views of the p53 dimer lacking DNA. Two p53 monomers (green and blue) were fit into the EM density map. Close-up view of a helix in the DBD shows some side chains ranging from R280-R290. Scale bar is 10 Å. (FIG. 10C) Particles were not limited in angular orientations according to their distribution plot. (FIG. 10D) The Fourier shell correlation (FSC) curve and Cref (0.5) evaluation show a resolution of 4.2 Å at the 0.143 value (purple line).

FIG. 11 shows images that were collected using a CETA camera integrated into an F200C TEM operating in bright-field mode at 200 kV under low-dose conditions (˜5 electron/Å²/sec). The nominal magnification was 142,000× with a final sampling of 0.98 Å/pixel/sec at the specimen level for 1 second exposures. Images were processed in the RELION software package and included CTF correction with automated particle picking using a box size of 100 pixels. 8000 total particles were selected for the p53 monomer and dimer structures. Reference-free classification procedures were performed using all particles that were subsequently employed for 3D refinement procedures. For 3D refinement, ab initio models were produced in RELION using C1 symmetry. Refinement cycles included 25 iterations to yield EM maps for each structure. C2 symmetry was used during refinement for the p53 dimer and C1 symmetry was used for the p53 monomer. The structural resolution was determined by comparing half-maps at the 0.143 value along with comparison to theoretical models, Cref (0.5) criteria. The p53 monomer resolution was ˜5 Å and the p53 dimer resolution was ˜4.2 Å. EM maps were imported into the PHENIX software package and auto-sharpened at the resolution determined in RELION. A homology model for p53 was produced in PHYRE 2 and imported into PHENIX. Rigid-body refinement was performed using standard procedures. The output model was evaluated and rebuilt into the p53 monomer map using molecular dynamics-flexible fitting (MD-FF) procedures in the ISOLDE program implemented in ChimeraX. Final statistics for the p53 structure were evaluated using the Molprobity program and are given in Table 3.

FIG. 12A, FIG. 12B, FIG. 12C, and FIG. 12D show Cryo-EM structure of the p53 monomer (FIG. 12A) EM structure of the p53 monomer shown in different rotational views with transparent and solid rendering (FIG. 12B). The structure was interpreted using an initial model that was fit into the map and subjected to rebuilding and refinement using the PHENIX and ISOLDE software packages. Scale bar is 5 Å. (FIG. 12C) The FSC curve and Cref (0.5) evaluation indicate a resolution of ˜5 Å at the 0.143 value (purple line). (FIG. 12D) Comparison between structural projections of the p53 monomer (top row) and class averages (bottom row).

### VII. DETAILED DESCRIPTION

Before the present compounds, compositions, articles, devices, and/or methods are disclosed and described, it is to be understood that they are not limited to specific synthetic methods or specific recombinant biotechnology methods unless otherwise specified, or to particular reagents unless otherwise specified, as such may, of course, vary. It is also to be understood that the terminology used herein is for the purpose of describing particular embodiments only and is not intended to be limiting.

### A. Definitions

As used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that the throughout the application, data is provided in a number of different formats, and that this data, represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

In this specification and in the claims which follow, reference will be made to a number of terms which shall be defined to have the following meanings:

“Optional” or “optionally” means that the subsequently described event or circumstance may or may not occur, and that the description includes instances where said event or circumstance occurs and instances where it does not.

An “increase” can refer to any change that results in a greater amount of a symptom, disease, composition, condition or activity. An increase can be any individual, median, or average increase in a condition, symptom, activity, composition in a statistically significant amount. Thus, the increase can be a 1, 2, 3, 4, 5, 6, 7, 8, 9, 10, 15, 20, 25, 30, 35, 40, 45, 50, 55, 60, 65, 70, 75, 80, 85, 90, 95, or 100% increase so long as the increase is statistically significant.

A “decrease” can refer to any change that results in a smaller amount of a symptom, disease, composition, condition, or activity. A substance is also understood to decrease the genetic output of a gene when the genetic output of the gene product with the substance is less relative to the output of the gene product without the substance. Also for example, a decrease can be a change in the symptoms of a disorder such that the symptoms are less than previously observed. A decrease can be any individual, median, or average decrease in a condition, symptom, activity, composition in a statistically significant amount. Thus, the decrease can be a 1, 2, 3, 4, 5, 6, 7, 8, 9, 10, 15, 20, 25, 30, 35, 40, 45, 50, 55, 60, 65, 70, 75, 80, 85, 90, 95, or 100% decrease so long as the decrease is statistically significant.

“Inhibit,” “inhibiting,” and “inhibition” mean to decrease an activity, response, condition, disease, or other biological parameter. This can include but is not limited to the complete ablation of the activity, response, condition, or disease. This may also include, for example, a 10% reduction in the activity, response, condition, or disease as compared to the native or control level. Thus, the reduction can be a 10, 20, 30, 40, 50, 60, 70, 80, 90, 100%, or any amount of reduction in between as compared to native or control levels.

By “reduce” or other forms of the word, such as “reducing” or “reduction,” is meant lowering of an event or characteristic (e.g., tumor growth). It is understood that this is typically in relation to some standard or expected value, in other words it is relative, but that it is not always necessary for the standard or relative value to be referred to. For example, “reduces tumor growth” means reducing the rate of growth of a tumor relative to a standard or a control.

By “prevent” or other forms of the word, such as “preventing” or “prevention,” is meant to stop a particular event or characteristic, to stabilize or delay the development or progression of a particular event or characteristic, or to minimize the chances that a particular event or characteristic will occur. Prevent does not require comparison to a control as it is typically more absolute than, for example, reduce. As used herein, something could be reduced but not prevented, but something that is reduced could also be prevented. Likewise, something could be prevented but not reduced, but something that is prevented could also be reduced. It is understood that where reduce or prevent are used, unless specifically indicated otherwise, the use of the other word is also expressly disclosed.

The term “subject” refers to any individual who is the target of administration or treatment. The subject can be a vertebrate, for example, a mammal. In one aspect, the subject can be human, non-human primate, bovine, equine, porcine, canine, or feline. The subject can also be a guinea pig, rat, hamster, rabbit, mouse, or mole. Thus, the subject can be a human or veterinary patient. The term “patient” refers to a subject under the treatment of a clinician, e.g., physician.

The term “therapeutically effective” refers to the amount of the composition used is of sufficient quantity to ameliorate one or more causes or symptoms of a disease or disorder. Such amelioration only requires a reduction or alteration, not necessarily elimination.

The term “treatment” refers to the medical management of a patient with the intent to cure, ameliorate, stabilize, or prevent a disease, pathological condition, or disorder. This term includes active treatment, that is, treatment directed specifically toward the improvement of a disease, pathological condition, or disorder, and also includes causal treatment, that is, treatment directed toward removal of the cause of the associated disease, pathological condition, or disorder. In addition, this term includes palliative treatment, that is, treatment designed for the relief of symptoms rather than the curing of the disease, pathological condition, or disorder; preventative treatment, that is, treatment directed to minimizing or partially or completely inhibiting the development of the associated disease, pathological condition, or disorder; and supportive treatment, that is, treatment employed to supplement another specific therapy directed toward the improvement of the associated disease, pathological condition, or disorder.

“Biocompatible” generally refers to a material and any metabolites or degradation products thereof that are generally non-toxic to the recipient and do not cause significant adverse effects to the subject.

“Comprising” is intended to mean that the compositions, methods, etc. include the recited elements, but do not exclude others. “Consisting essentially of” when used to define compositions and methods, shall mean including the recited elements, but excluding other elements of any essential significance to the combination. Thus, a composition consisting essentially of the elements as defined herein would not exclude trace contaminants from the isolation and purification method and pharmaceutically acceptable carriers, such as phosphate buffered saline, preservatives, and the like. “Consisting of” shall mean excluding more than trace elements of other ingredients and substantial method steps for administering the compositions provided and/or claimed in this disclosure. Embodiments defined by each of these transition terms are within the scope of this disclosure.

“Complementary” or “substantially complementary” refers to the hybridization or base pairing or the formation of a duplex between nucleotides or nucleic acids, such as, for instance, between the two strands of a double stranded DNA molecule or between an oligonucleotide primer and a primer binding site on a single stranded nucleic acid. Complementary nucleotides are, generally, A and T/U, or C and G. Two single-stranded RNA or DNA molecules are said to be substantially complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, substantial complementarity exists when an RNA or DNA strand will hybridize under selective hybridization conditions to its complement. Typically, selective hybridization will occur when there is at least about 65% complementary over a stretch of at least 14 to 25 nucleotides, at least about 75%, or at least about 90% complementary. See Kanehisa (1984) Nucl. Acids Res. 12:203.

A “control” is an alternative subject or sample used in an experiment for comparison purposes. A control can be “positive” or “negative.”

“Effective amount” of an agent refers to a sufficient amount of an agent to provide a desired effect. The amount of agent that is “effective” will vary from subject to subject, depending on many factors such as the age and general condition of the subject, the particular agent or agents, and the like. Thus, it is not always possible to specify a quantified “effective amount.” However, an appropriate “effective amount” in any subject case may be determined by one of ordinary skill in the art using routine experimentation. Also, as used herein, and unless specifically stated otherwise, an “effective amount” of an agent can also refer to an amount covering both therapeutically effective amounts and prophylactically effective amounts. An “effective amount” of an agent necessary to achieve a therapeutic effect may vary according to factors such as the age, sex, and weight of the subject. Dosage regimens can be adjusted to provide the optimum therapeutic response. For example, several divided doses may be administered daily or the dose may be proportionally reduced as indicated by the exigencies of the therapeutic situation.

A “pharmaceutically acceptable” component can refer to a component that is not biologically or otherwise undesirable, i.e., the component may be incorporated into a pharmaceutical formulation provided by the disclosure and administered to a subject as described herein without causing significant undesirable biological effects or interacting in a deleterious manner with any of the other components of the formulation in which it is contained. When used in reference to administration to a human, the term generally implies the component has met the required standards of toxicological and manufacturing testing or that it is included on the Inactive Ingredient Guide prepared by the U.S. Food and Drug Administration.

“Pharmaceutically acceptable carrier” (sometimes referred to as a “carrier”) means a carrier or excipient that is useful in preparing a pharmaceutical or therapeutic composition that is generally safe and non-toxic and includes a carrier that is acceptable for veterinary and/or human pharmaceutical or therapeutic use. The terms “carrier” or “pharmaceutically acceptable carrier” can include, but are not limited to, phosphate buffered saline solution, water, emulsions (such as an oil/water or water/oil emulsion) and/or various types of wetting agents. As used herein, the term “carrier” encompasses, but is not limited to, any excipient, diluent, filler, salt, buffer, stabilizer, solubilizer, lipid, stabilizer, or other material well known in the art for use in pharmaceutical formulations and as described further herein.

“Pharmacologically active” (or simply “active”), as in a “pharmacologically active” derivative or analog, can refer to a derivative or analog (e.g., a salt, ester, amide, conjugate, metabolite, isomer, fragment, etc.) having the same type of pharmacological activity as the parent compound and approximately equivalent in degree.

“Therapeutic agent” refers to any composition that has a beneficial biological effect. Beneficial biological effects include both therapeutic effects, e.g., treatment of a disorder or other undesirable physiological condition, and prophylactic effects, e.g., prevention of a disorder or other undesirable physiological condition (e.g., a non-immunogenic cancer). The terms also encompass pharmaceutically acceptable, pharmacologically active derivatives of beneficial agents specifically mentioned herein, including, but not limited to, salts, esters, amides, proagents, active metabolites, isomers, fragments, analogs, and the like. When the terms “therapeutic agent” is used, then, or when a particular agent is specifically identified, it is to be understood that the term includes the agent per se as well as pharmaceutically acceptable, pharmacologically active salts, esters, amides, proagents, conjugates, active metabolites, isomers, fragments, analogs, etc.

“Therapeutically effective amount” or “therapeutically effective dose” of a composition (e.g., a composition comprising an agent) refers to an amount that is effective to achieve a desired therapeutic result. In some embodiments, a desired therapeutic result is the control of cancer. In some embodiments, a desired therapeutic result is the prevention of relapse. Therapeutically effective amounts of a given therapeutic agent will typically vary with respect to factors such as the type and severity of the disorder or disease being treated and the age, gender, and weight of the subject. The term can also refer to an amount of a therapeutic agent, or a rate of delivery of a therapeutic agent (e.g., amount over time), effective to facilitate a desired therapeutic effect, such as pain relief The precise desired therapeutic effect will vary according to the condition to be treated, the tolerance of the subject, the agent and/or agent formulation to be administered (e.g., the potency of the therapeutic agent, the concentration of agent in the formulation, and the like), and a variety of other factors that are appreciated by those of ordinary skill in the art. In some instances, a desired biological or medical response is achieved following administration of multiple dosages of the composition to the subject over a period of days, weeks, or years.

“Encoding” refers to the inherent property of specific sequences of nucleotides in a polynucleotide, such as a gene, a cDNA, or an mRNA, to serve as templates for synthesis of other polymers and macromolecules in biological processes having either a defined sequence of nucleotides (i.e., rRNA, tRNA and mRNA) or a defined sequence of amino acids and the biological properties resulting therefrom, Thus, a gene encodes a protein if transcription and translation of mRNA.

As used herein, “nucleic acid” means a polynucleotide and includes a single or a double-stranded polymer of deoxyribonucleotide or ribonucleotide bases. Nucleic acids may also include fragments and modified nucleotides. Thus, the terms “polynucleotide”, “nucleic acid sequence”, “nucleotide sequence” and “nucleic acid fragment” are used interchangeably to denote a polymer of RNA and/or DNA and/or RNA-DNA that is single- or double-stranded, optionally comprising synthetic, non-natural, or altered nucleotide bases. On occasion double-stranded DNA will be referred to “duplex DNA” or “dsDNA”. Nucleotides (usually found in their 5′-monophosphate form) are referred to by their single letter designation as follows: “A” for adenosine or deoxyadenosine (for RNA or DNA, respectively), “C” for cytosine or deoxycytosine, “G” for guanosine or deoxyguanosine, “U” for uridine, “T” for deoxythymidine, “R” for purines (A or G), “Y” for pyrimidines (C or T), “K” for G or T, “H” for A or C or T, “I” for inosine, and “N” for any nucleotide.

The term “genome” as it applies to a prokaryotic and eukaryotic cell or organism cells encompasses not only chromosomal DNA found within the nucleus, but organelle DNA found within subcellular components (e.g., mitochondria, or plastid) of the cell.

By “homology” is meant DNA sequences that are similar. For example, a “region of homology to a genomic region” that is found on the donor DNA is a region of DNA that has a similar sequence to a given “genomic region” in the cell or organism genome. A region of homology can be of any length that is sufficient to promote homologous recombination at the cleaved target site. For example, the region of homology can comprise at least 5-10, 5-15, 5-20, 5-25, 5-30, 5-35, 5-40, 5-45, 5- 50, 5-55, 5-60, 5-65, 5- 70, 5-75, 5-80, 5-85, 5-90, 5-95, 5-100, 5-200, 5-300, 5-400, 5-500, 5-600, 5-700, 5-800, 5-900, 5-1000, 5-1100, 5-1200, 5-1300, 5-1400, 5-1500, 5-1600, 5-1700, 5-1800, 5-1900, 5-2000, 5-2100, 5-2200, 5-2300, 5-2400, 5-2500, 5-2600, 5-2700, 5-2800, 5-2900, 5-3000, 5-3100 or more bases in length such that the region of homology has sufficient homology to undergo homologous recombination with the corresponding genomic region.

“Sequence identity” or “identity” in the context of nucleic acid or polypeptide sequences refers to the nucleic acid bases or amino acid residues in two sequences that are the same when aligned for maximum correspondence over a specified comparison window.

The term “percentage of sequence identity” refers to the value determined by comparing two optimally aligned sequences over a comparison window, wherein the portion of the polynucleotide or polypeptide sequence in the comparison window may comprise additions or deletions (i.e., gaps) as compared to the reference sequence (which does not comprise additions or deletions) for optimal alignment of the two sequences. The percentage is calculated by determining the number of positions at which the identical nucleic acid base or amino acid residue occurs in both sequences to yield the number of matched positions, dividing the number of matched positions by the total number of positions in the window of comparison and multiplying the results by 100 to yield the percentage of sequence identity. Useful examples of percent sequence identities include, but are not limited to, 50%, 55%, 60%, 65%, 70%, 75%, 80%, 85%, 90%, or 95%, or any percentage from 50% to 100%. These identities can be determined using any of the programs described herein.

Sequence alignments and percent identity or similarity calculations may be determined using a variety of comparison methods designed to detect homologous sequences including, but not limited to, the MegAlign™ program of the LASERGENE bioinformatics computing suite (DNASTAR Inc., Madison, Wis.). Within the context of this application, it will be understood that where sequence analysis software is used for analysis, that the results of the analysis will be based on the “default values” of the program referenced, unless otherwise specified. As used herein “default values” will mean any set of values or parameters that originally load with the software when first initialized.

Polynucleotide and polypeptide sequences, variants thereof, and the structural relationships of these sequences can be described by the terms “homology”, “homologous”, “substantially identical”, “substantially similar” and” corresponding substantially” which are used interchangeably herein. These refer to polypeptide or nucleic acid sequences wherein changes in one or more amino acids or nucleotide bases do not affect the function of the molecule, such as the ability to mediate gene expression or to produce a certain phenotype. These terms also refer to modification(s) of nucleic acid sequences that do not substantially alter the functional properties of the resulting nucleic acid relative to the initial, unmodified nucleic acid. These modifications include deletion, substitution, and/or insertion of one or more nucleotides in the nucleic acid fragment. Substantially similar nucleic acid sequences encompassed may be defined by their ability to hybridize (under moderately stringent conditions, e.g., 0.5× SSC, 0.1% SDS, 60° C.) with the sequences exemplified herein, or to any portion of the nucleotide sequences disclosed herein and which are functionally equivalent to any of the nucleic acid sequences disclosed herein. Stringency conditions can be adjusted to screen for moderately similar fragments, such as homologous sequences from distantly related organisms to highly similar fragments, such as genes that duplicate functional enzymes from closely related organisms. Post-hybridization washes determine stringency conditions.

An “isolated” or “purified” nucleic acid molecule, polynucleotide, polypeptide, or protein, or biologically active portion thereof, is substantially or essentially free from components that normally accompany or interact with the polynucleotide or protein as found in its naturally occurring environment. Thus, an isolated or purified polynucleotide or polypeptide or protein is substantially free of other cellular material, or culture medium when produced by recombinant techniques, or substantially free of chemical precursors or other chemicals when chemically synthesized. Optimally, an “isolated” polynucleotide is free of sequences (optimally protein encoding sequences) that naturally flank the polynucleotide (i.e., sequences located at the 5′ and 3′ ends of the polynucleotide) in the genomic DNA of the organism from which the polynucleotide is derived. For example, in various embodiments, the isolated polynucleotide can contain less than about 5 kb, 4 kb, 3 kb, 2 kb, 1 kb, 0.5 kb, or 0.1 kb of nucleotide sequence that naturally flank the polynucleotide in genomic DNA of the cell from which the polynucleotide is derived. Isolated polynucleotides may be purified from a cell in which they naturally occur. Conventional nucleic acid purification methods known to skilled artisans may be used to obtain isolated polynucleotides. The term also embraces recombinant polynucleotides and chemically synthesized polynucleotides.

The term “fragment” refers to a contiguous set of nucleotides or amino acids. In one embodiment, a fragment is 2, 3, 4, 5, 6, 7 8, 9, 10, 11, 12, 13, 14, 15, 16, 17, 18, 19, 20, or greater than 20 contiguous nucleotides. In one embodiment, a fragment is 2, 3, 4, 5, 6, 7 8, 9, 10, 11, 12, 13, 14, 15, 16, 17, 18, 19, 20, or greater than 20 contiguous amino acids. A fragment may or may not exhibit the function of a sequence sharing some percent identity over the length of said fragment.

“Gene” includes a nucleic acid fragment that expresses a functional molecule such as, but not limited to, a specific protein, including regulatory sequences preceding (5′ noncoding sequences) and following (3′ non-coding sequences) the coding sequence. “Native gene” refers to a gene as found in its natural endogenous location with its own regulatory sequences.

“Coding sequence” refers to a polynucleotide sequence which codes for a specific amino acid sequence. “Regulatory sequences” refer to nucleotide sequences located upstream (5′ non-coding sequences), within, or downstream (3′ non-coding sequences) of a coding sequence, and which influence the transcription, RNA processing or stability, or translation of the associated coding sequence. Regulatory sequences include, but are not limited to, promoters, translation leader sequences, 5′ untranslated sequences, 3′ untranslated sequences, introns, polyadenylation target sequences, RNA processing sites, effector binding sites, and stem-loop structures.

A “mutated gene” is a gene that has been altered through human intervention. Such a “mutated gene” has a sequence that differs from the sequence of the corresponding non-mutated gene by at least one nucleotide addition, deletion, or substitution.

As used herein, a “targeted mutation” is a mutation in a gene (referred to as the target gene), including a native gene, that was made by altering a target sequence within the target gene using any method known to one skilled in the art, including, for example, a method involving a guided Cas endonuclease system, siRNA, or shRNA as disclosed herein.

“CRISPR” (Clustered Regularly Interspaced Short Palindromic Repeats) loci refers to certain genetic loci encoding components of DNA cleavage systems, for example, used by bacterial and archaeal cells to destroy foreign DNA (Horvath and Barrangou, 2010, Science 327: 167-170; W02007025097, published 1 Mar. 2007). A CRISPR locus can consist of a CRISPR array, comprising short direct repeats (CRISPR repeats) separated by short variable DNA sequences (called spacers), which can be flanked by diverse Cas (CRISPR-associated) genes.

As used herein, an “effector” or “effector protein” is a protein that encompasses an activity including recognizing, binding to, and/or cleaving or nicking a polynucleotide target. An effector, or effector protein, may also be an endonuclease. The “effector complex” of a CRISPR system includes Cas proteins involved in crRNA and target recognition and binding. Some of the component Cas proteins may additionally comprise domains involved in target polynucleotide cleavage.

The term “Cas protein” refers to a polypeptide encoded by a Cas (CRISPR-associated) gene. A Cas protein includes proteins encoded by a gene in a cas locus and includes adaptation molecules as well as interference molecules. An interference molecule of a bacterial adaptive immunity complex includes endonucleases. A Cas endonuclease described herein comprises one or more nuclease domains. Contemplated herein are any Cas molecules that comprise a Rec3 clamp, as described below.

A Cas protein is further defined as a functional fragment or functional variant of a native Cas protein, or a protein that shares at least 30%, between 30% and 35%, at least 35%, between 35% and 40%, at least 40%, between 40% and 45%, at least 45%, between 45% and 50%, at least 50%, between 50% and 55%, at least 55%, between 55% and 60%, at least 60%, between 60% and 65%, at least 65%, between 65% and 70%, at least 70%, between 70% and 75%, at least 75%, between 75% and 80%, at least 80%, between 80% and 85%, at least 85%, between 85% and 90%, at least 90%, between 90% and 95%, at least 95%, between 95% and 96%, at least 96%, between 96% and 97%, at least 97%, between 97% and 98%, at least 98%, between 98% and 99%, at least 99%, between 99% and 100%, or 100% sequence identity with at least 50, between 50 and 100, at least 100, between 100 and 150, at least 150, between 150 and 200, at least 200, between 200 and 250, at least 250, between 250 and 300, at least 300, between 300 and 350, at least 350, between 350 and 400, at least 400, between 400 and 450, at least 500, or greater than 500 contiguous amino acids of a native Cas protein, and retains at least partial activity of the native sequence.

A Cas endonuclease may also include a multifunctional Cas endonuclease. The term “multifunctional Cas endonuclease” and “multifunctional Cas endonuclease polypeptide” are used interchangeably herein and includes reference to a single polypeptide that has Cas endonuclease functionality (comprising at least one protein domain that can act as a Cas endonuclease) and at least one other functionality, such as but not limited to, the functionality to form a complex (comprises at least a second protein domain that can form a complex with other proteins). In one aspect, the multifunctional Cas endonuclease comprises at least one additional protein domain relative (either internally, upstream (5′), downstream (3′), or both internally 5′ and 3′, or any combination thereof) to those domains typical of a Cas endonuclease.

As used herein, the term “guide polynucleotide”, relates to a polynucleotide sequence that can form a complex with a Cas endonuclease, including the Cas endonuclease described herein, and enables the Cas endonuclease to recognize, optionally bind to, and optionally cleave a DNA target site. The guide polynucleotide sequence can be a RNA sequence, a DNA sequence, or a combination thereof (a RNA-DNA combination sequence).

The terms “single guide RNA” and “sgRNA” are used interchangeably herein and relate to a synthetic fusion of two RNA molecules, a crRNA (CRISPR RNA) comprising a variable targeting domain (linked to a tracr mate sequence that hybridizes to a tracrRNA), fused to a tracrRNA (trans-activating CRISPR RNA).

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon.

The mechanism of action of p53 depends largely on its conformational state. Historic data suggests that monomers, dimers and tetramers may all bind to DNA in vitro. The specific DNA consensus sequence for p53 binding is: 5′-PuPuC(A/T)(T/A)GPyPy-3′, where Pu represents purines and Py represent pyrimidines. Although monomers may partially bind to the sequence, cellular experiment demonstrated that p53 tetramers are abundantly found at DNA consensus sites. P53 tetramers are stabilized through protein-protein interactions between DBDs as well as through DNA bending at specific binding sites. In vitro and in vivo models suggest that p53 dimers are co-translated on the polysome, supporting the idea that monomers are less prevalent in cells and that dimer intermediates are needed for DNA repair.

Regulatory regions within the NTD and CTD of p53 ensure the exquisite timing of DNA repair events to avoid unintentional missteps. The NTD contains a transactivation domain that interacts with other regulatory binding partners such as MDM2. At the other end of the protein, the CTD has been reported to block the DNA-binding domain while in a latent conformation. It has also been reported that PTMs can modify and prevent the blocking mechanism, leaving p53 in a perpetually active state. Other studies have shown that the CTD acts in a tissue-dependent manner to promote apoptotic activity. Equally important, p53 has proteolytic activity dependent on the identity of the DNA source. When bound to mismatched DNA or single-stranded DNA, p53 self-cleavage events can trigger apoptotic signaling cascades. While decades of reports describe the multi-tasking ability of p53, structural evidence to support these varying states remains murky. Expanding our knowledge of full-length p53 in different functional forms holds tremendous value for the research community. As cryo-Electron Microscopy (EM) now has the imaging power to resolve flexible structures of small proteins, this technology may address structural deficits in the p53 field.

Structures of natively sourced proteins are limited by our ability to obtain pure samples from human cells. This limitation has led researchers to study recombinant proteins, potentially devoid of the post-translational modifications (PTMs) that influence p53 function. To overcome these challenges, a highly reproducible protein enrichment method has been developed that incorporates microchip-based tools for cryo-EM analysis. These procedures yielded novel structures of p53 monomers (˜50 kDa) and tetramers (˜200 kDa). These rapid extraction methods exploit the inherent properties of p53 in its native, phosphorylated form. Phosphorylated p53 binds to metal cations through Immobilized Metal Affinity Chromatography (IMAC). Enriched p53 fractions were further concentrated for structural studies using specialized Silicon Nitride (SiN)-based microchips. The microchips, (such as Cryo-Chips™), contain windows that are 5-10-fold lamer than the average holey carbon grid areas commonly used to prepare cryo-EM samples. Here tools disclosed herein are applied to expand the knowledge of p53 dimer active and inactive assemblies while defining a new model for p53 activation at DNA sites.

In one aspect, disclosed herein are methods of resolving a structure of a full-length protein, said method comprising isolating the protein of interest, applying the protein to a microchip with or without functionalized coatings, and creating an electron microscopy (EM) map (such as, for example, by calculating multimeric structures and modeling the molecular structure of the protein; constructing a full-length protein model using protein prediction software and fitting the structure into an EM map using rigid-body refinement), optionally along with complementary biochemical on-chip testing assays for downstream characterization. Such characterization steps may include Mass Spectrometry analysis, SDS-PAGE analysis, Surface Plasmon Resonance analysis, Enzyme-linked immunoassays, lateral-flow cassette analysis, on-chip microfluidic analysis, Atomic force microscopy, Scanning Transmission EM (STEM), and/or chemical mapping analysis. In some embodiments, the microchip comprises silicon nitride (SiN).

In some aspects, the protein structure is resolved in a liquid solution. Viewing biological samples in a dynamic, liquid setting can significantly expand structural observations. It is highly desirable to pair high-resolution information with real-time dynamics to better interpret biological events in rapid timeframes—the order of milliseconds or faster. Such rapid events may include changes in pliable proteins loops that serve as ubiquitination sites on tumor suppressor. Improved knowledge of these flexible structures may impact the design of antibody therapies or even anti-viral reagents to combat SARS-CoV-2 infection. Importantly, viewing biological materials in a fluid, stochastic environment provides unique insight of their performance in the human body.

As used herein, the disclosed methods comprise applying the protein to a microchip. The microchip used herein can be any microchip available on the market. For example, the microchip can comprise silicon Nitride microchips (Protochips, Inc.). In some aspects the microchip comprises integrated microwells. Additionally, the microchips were coated with Ni-NTA lipid monolayers that served to enrich and purify p53 assemblies. Thus, in one aspect, also disclosed herein are method of resolving a full-length protein structure, wherein the microchip comprises microwells are coated with nickel-nitrilotriacetic (Ni-NTA).

Microwell size of the disclosed microchips can be any size from about 1 nm to about 500 nm, preferably about 50 nm to about 300 nm, more preferably about 100 to about 200 nm, for example, the microwells can be about 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 210, 220, 230, 240, 250, 260, 270, 280, 290, 300, 325, 350, 375, 400, 425, 450, 475, or 500 nm in size. In some aspects, the microchip can further comprise a carbon grid.

The disclosed methods creating an electron microscopy (EM) map. Such maps can be created as described herein, for example, by calculating dimer structures and modeling the molecular structure of the protein; constructing a full-length protein model using protein prediction software and fitting the structure into an EM map using rigid-body refinement. For example creation of the EM map can comprise structures of dimers can be calculated using the RELION software package and molecular modeling performed using the UCSF Chimera software program. A model for full-length proteins can be built using the PHYRE 2 protein prediction server and fit into the EM map using rigid-body refinement techniques.

It is understood and herein contemplated that the ability to fully and accurately resolve a full-length protein as a monomer, dimer, trimer, tetramer, pentamer, hexamer, septamer, octamer, nonamer, and/or decamer allows for the identification of amino acid residues that are critical to the function of the protein or, in the case of a mutant protein, the loss of function or mutated phenotype. Accordingly, the methods herein can be used to identify novel therapeutic targets on a protein of interest (such as, for example, p53 or a mutated p53). Thus, in one aspect, disclosed herein are methods of identifying a therapeutic target, said method comprising isolating the protein of interest, applying the protein to a microchip, and creating an electron microscopy (EM) map; wherein the EM map is created by calculating the multimeric structures (e.g., dimeric structures) and modeling the molecular structure of the protein; constructing a full-length protein model using protein prediction software and fitting the full-length protein model into an EM map using rigid-body refinement; and assaying individual residues in a DNA-bound model for mutations at residues that do not directly interact with the helical backbone, mutations that effect post translational modification sites, and mutations at residues that contact the helical backbone; wherein an identified mutation comprises a therapeutic target. In some embodiments, the full-length protein comprises a multimeric structure comprising more than one monomer. As noted herein, the methods disclosed herein are able to identify residues (such as, for example, K120, R283, T284, K291, K292, G293, and/or E294 relative to SEQ ID NO: 1) that are important to the ability of p53 to bind DNA or effect post-translational modification and were, prior to the present disclosure, not identified as therapeutic targets. Nonetheless, the novel therapeutic target is not limited to cancer targets but can also be targets on any protein that may have a therapeutic effect, including, but not limited to viral proteins, bacterial proteins, fungal proteins, proteins from parasites, or any other aberrant proteins associated with a disease state.

By using the targets identified using the disclosed methods, the skilled artisan can also screen for novel therapeutic agents that bind to said targets. Thus, in one aspect, disclosed herein are methods of screening for a therapeutic agent that treats a cancer comprising a mutated p53, the method comprising contacting a mutated p53 polypeptide with a therapeutic agent; measuring the interaction between the therapeutic agent and the mutated p53 polypeptide; and determining the therapeutic agent as for treating the cancer if said therapeutic agent selectively targets the mutated p53 polypeptide or a polynucleotide encoding the polypeptide, wherein the mutated p53 polypeptide comprises one or more mutations at residue K120, 5122, R175, S241, G245, R248, R249, R273, C275, R280, R282, R283, T284, K291, K292, G293, E294, and/or H297 relative to SEQ ID NO: 1. Again, the target is not limited to proteins involved in cancer and, in particular, p53 and can work for any protein associated with a disease state. Thus, the disclosed screening methods can also be used to screen for therapeutic agents that bind to a therapeutic target on viral proteins, bacterial proteins, fungal proteins, proteins from parasites, or any other aberrant proteins associated with a disease state.

Also disclosed herein are methods of screening for a therapeutic agent that treats a cancer comprising a mutated p53, the method comprising
contacting a mutated p53 polypeptide with a therapeutic agent;
measuring the interaction between the therapeutic agent and the mutated p53 polypeptide; and
determining the therapeutic agent as for treating the cancer if said therapeutic agent selectively targets the mutated p53 polypeptide or a polynucleotide encoding the polypeptide, wherein the mutated p53 polypeptide comprises one or more mutations at residue K120, 5122, R175, 5241, G245, R248, R249, R273, C275, R280, R282, R283, T284, K291, K292, G293, E294, and/or H297 relative to SEQ ID NO: 1.

In some embodiments, the mutated p53 polypeptide comprises one or more mutations at residue K120, R283, T284, K291, K292, G293, and/or E294 relative to SEQ ID NO: 1. In some embodiments, the interaction between the therapeutic agent and the mutated p53 is measured by cryo-electron microscopy (cryo-EM).

It is understood and herein contemplated that by identifying an agent that binds to a therapeutic target, it is possible to treat a disease (such as, for example, a cancer and or metastasis) comprising the protein target with said agent. Accordingly, in one aspect, disclosed herein are methods of treating, inhibiting, reducing, decreasing, ameliorating, and/or preventing a cancer and/or metastasis comprising a mutated p53 (such as, for example a breast cancer, lung cancer, pancreatic cancer, or glioblastoma) in a subject comprising administering to the subject a therapeutic agent that selectively targets a mutated p53 polypeptide or a polynucleotide encoding the mutated p53 polypeptide, wherein the mutated p53 polypeptide comprises one or more mutations at residue K120, 5122, R175, S241, G245, R248, R249, R273, C275, R280, R282, R283, T284, K291, K292, G293, E294, and/or H297 relative to SEQ ID NO: 1. In some embodiments, the mutated p53 polypeptide comprises one or more mutations at residue K120, R283, T284, K291, K292, G293, and/or E294 relative to SEQ ID NO: 1. In some embodiments, the therapeutic agent is a polypeptide, a polynucleotide, a small molecule, or a gene editing tool. In some embodiments, the polypeptide is an antibody. In some embodiments, the polynucleotide is a small interfering RNA (siRNA) or a short hairpin RNA (shRNA). In some embodiments, the method disclosed herein comprises administering to a subject in need an siRNA or shRNA complementary to the one or more the mutations on the polynucleotide encoding the mutated p53 polypeptide, wherein the mutated p53 polypeptide comprises one or more mutations at residue K120, S122, R175, 5241, G245, R248, R249, R273, C275, R280, R282, R283, T284, K291, K292, G293, E294, and/or H297 relative to SEQ ID NO: 1. In some embodiments, the method disclosed herein comprises administering to a subject in need a CRISPR/Cas endonuclease system comprising a gRNA complementary to the one or more the mutations on the polynucleotide encoding the mutated p53 polypeptide, wherein the mutated p53 polypeptide comprises one or more mutations at residue K120, S122, R175, S241, G245, R248, R249, R273, C275, R280, R282, R283, T284, K291, K292, G293, E294, and/or H297 relative to SEQ ID NO: 1 . In some embodiments, the mutated p53 polypeptide comprises one or more mutations at residue K120, R283, T284, K291, K292, G293, and/or E294 relative to SEQ ID NO: 1. In some embodiments, the mutated p53 polypeptide comprises a mutation at residue K120 relative to SEQ ID NO: 1. In some embodiments, the mutated p53 polypeptide comprises a mutation at residue R283 relative to SEQ ID NO: 1. In some embodiments, the mutated p53 polypeptide comprises a mutation at residue T284 relative to SEQ ID NO: 1. In some embodiments, the mutated p53 polypeptide comprises a mutation at residue K291 relative to SEQ ID NO: 1. In some embodiments, the mutated p53 polypeptide comprises a mutation at residue K292 relative to SEQ ID NO: 1. In some embodiments, the mutated p53 polypeptide comprises a mutation at residue G293 relative to SEQ ID NO: 1. In some embodiments, the mutated p53 polypeptide comprises a mutation at residue E294 relative to SEQ ID NO: 1. In some embodiments, the mutated p53 polypeptide comprises mutations at residues K120, R283, T284, K291, K292, G293, and E294 relative to SEQ ID NO: 1.

In some examples, the small interfering RNA (siRNA), short hairpin RNA (shRNA), or CRISPR-Cas9 system disclosed herein decreases or silence an expression level of the targeted mutated p53.

The term “silencing” as used herein refers to suppression of expression of the (target) gene. It does not necessarily imply reduction of transcription, because gene silencing is believed to operate in at least some cases post-transcriptionally. The degree of gene silencing can be complete so as to abolish production of the encoded gene product (yielding a null phenotype), but more generally the gene expression is partially silenced, with some degree of expression remaining (yielding an intermediate phenotype). The term should not therefore be taken to require complete “silencing” of expression.

siRNA, also known as short interfering RNA or silencing RNA, is a class of double-stranded RNA molecules (for examples, 20-25 base pairs in length), which interferes with the expression of specific genes with complementary nucleotide sequences by degrading mRNA after transcription, preventing translation (Agrawal et al., Microbiol. lvfol. Biol. Rev., 67(4): 657-668 (2003). shRNAs are artificial RNA molecules with a tight hairpin tum that can be used to silence target gene expression via RNAi.

In general, “CRISPR system” refers collectively to transcripts and other elements involved in the expression of or directing the activity of CRISPR-associated (“Cas”) genes, including sequences encoding a Cas gene, a tracr (trans-activating CRISPR) sequence (e.g. tracrRNA or an active partial tracrRNA), a tracr-mate sequence (encompassing a “direct repeat” and a tracrRNA-processed partial direct repeat in the context of an endogenous CRISPR system), a guide sequence (also referred to as a “spacer” in the context of an endogenous CRISPR system), or other sequences and transcripts from a CRISPR locus. In some embodiments, one or more elements of a CRISPR system is derived from a type I, type II, or type III CRISPR system. CRISPR systems are known in the art. See, e.g., U.S. Pat. No. 8,697,359, incorporated by reference herein in its entirety.

The disclosed residues on p53 identified herein (for example, mutations on residues K120, R283, T284, K291, K292, G293, or E294 relative to SEQ ID NO:1) can be used as targets for the treatment of any disease where uncontrolled cellular proliferation occurs such as cancers. A representative but non-limiting list of cancers that the disclosed compositions can be used to treat is the following: lymphoma, B cell lymphoma, T cell lymphoma, mycosis fungoides, Hodgkin's Disease, myeloid leukemia, bladder cancer, brain cancer, nervous system cancer, head and neck cancer, squamous cell carcinoma of head and neck, lung cancers such as small cell lung cancer and non-small cell lung cancer, neuroblastoma/glioblastoma, ovarian cancer, skin cancer, liver cancer, melanoma, squamous cell carcinomas of the mouth, throat, larynx, and lung, cervical cancer, cervical carcinoma, breast cancer, and epithelial cancer, renal cancer, genitourinary cancer, pulmonary cancer, esophageal carcinoma, head and neck carcinoma, large bowel cancer, hematopoietic cancers; testicular cancer; colon cancer, rectal cancer, prostatic cancer, or pancreatic cancer.

In one aspect, it is understood and herein contemplated that successful treatment of a cancer in a subject is important and doing so may include the administration of additional treatments. Thus, the disclosed methods of treating, reducing, inhibiting, decreasing, ameliorating and/or preventing a cancer and/or metastasis can include or further include any anti-cancer therapy known in the art including, but not limited to Abemaciclib, Abiraterone Acetate, Abitrexate (Methotrexate), Abraxane (Paclitaxel Albumin-stabilized Nanoparticle Formulation), ABVD, ABVE, ABVE-PC, AC, AC-T, Adcetris (Brentuximab Vedotin), ADE, Ado-Trastuzumab Emtansine, Adriamycin (Doxorubicin Hydrochloride), Afatinib Dimaleate, Afinitor (Everolimus), Akynzeo (Netupitant and Palonosetron Hydrochloride), Aldara (Imiquimod), Aldesleukin, Alecensa (Alectinib), Alectinib, Alemtuzumab, Alimta (Pemetrexed Disodium), Aliqopa (Copanlisib Hydrochloride), Alkeran for Injection (Melphalan Hydrochloride), Alkeran Tablets (Melphalan), Aloxi (Palonosetron Hydrochloride), Alunbrig (Brigatinib), Ambochlorin (Chlorambucil), Amboclorin Chlorambucil), Amifostine, Aminolevulinic Acid, Anastrozole, Aprepitant, Aredia (Pamidronate Disodium), Arimidex (Anastrozole), Aromasin (Exemestane),Arranon (Nelarabine), Arsenic Trioxide, Arzerra (Ofatumumab), Asparaginase Erwinia chrysanthemi, Atezolizumab, Avastin (Bevacizumab), Avelumab, Axitinib, Azacitidine, Bavencio (Avelumab), BEACOPP, Becenum (Carmustine), Beleodaq (Belinostat), Belinostat, Bendamustine Hydrochloride, BEP, Besponsa (Inotuzumab Ozogamicin), Bevacizumab, Bexarotene, Bexxar (Tositumomab and Iodine I 131 Tositumomab), Bicalutamide, BiCNU (Carmustine), Bleomycin, Blinatumomab, Blincyto (Blinatumomab), Bortezomib, Bosulif (Bosutinib), Bosutinib, Brentuximab Vedotin, Brigatinib, BuMel, Busulfan, Busulfex (Busulfan), Cabazitaxel, Cabometyx (Cabozantinib-S-Malate), Cabozantinib-S-Malate, CAF, Campath (Alemtuzumab), Camptosar, (Irinotecan Hydrochloride), Capecitabine, CAPDX, Carac (Fluorouracil—Topical), Carboplatin, CARBOPLATIN-TAXOL, Carfilzomib, Carmubris (Carmustine), Carmustine, Carmustine Implant, Casodex (Bicalutamide), CEM, Ceritinib, Cerubidine (Daunorubicin Hydrochloride), Cervarix (Recombinant HPV Bivalent Vaccine), Cetuximab, CEV, Chlorambucil, CHLORAMBUCIL-PREDNISONE, CHOP, Cisplatin, Cladribine, Clafen (Cyclophosphamide), Clofarabine, Clofarex (Clofarabine), Clolar (Clofarabine), CMF, Cobimetinib, Cometriq (Cabozantinib-S-Malate), Copanlisib Hydrochloride, COPDAC, COPP, COPP-ABV, Cosmegen (Dactinomycin), Cotellic (Cobimetinib), Crizotinib, CVP, Cyclophosphamide, Cyfos (Ifosfamide), Cyramza (Ramucirumab), Cytarabine, Cytarabine Liposome, Cytosar-U (Cytarabine), Cytoxan (Cyclophosphamide), Dabrafenib, Dacarbazine, Dacogen (Decitabine), Dactinomycin, Daratumumab, Darzalex (Daratumumab), Dasatinib, Daunorubicin Hydrochloride, Daunorubicin Hydrochloride and Cytarabine Liposome, Decitabine, Defibrotide Sodium, Defitelio (Defibrotide Sodium), Degarelix, Denileukin Diftitox, Denosumab, DepoCyt (Cytarabine Liposome), Dexamethasone, Dexrazoxane Hydrochloride, Dinutuximab, Docetaxel, Doxil (Doxorubicin Hydrochloride Liposome), Doxorubicin Hydrochloride, Doxorubicin Hydrochloride Liposome, Dox-SL (Doxorubicin Hydrochloride Liposome), DTIC-Dome (Dacarbazine), Durvalumab, Efudex (Fluorouracil—Topical), Elitek (Rasburicase), Ellence (Epirubicin Hydrochloride), Elotuzumab, Eloxatin (Oxaliplatin), Eltrombopag Olamine, Emend (Aprepitant), Empliciti (Elotuzumab), Enasidenib Mesylate, Enzalutamide, Epirubicin Hydrochloride, EPOCH, Erbitux (Cetuximab), Eribulin Mesylate, Erivedge (Vismodegib), Erlotinib Hydrochloride, Erwinaze (Asparaginase Erwinia chrysanthemi), Ethyol (Amifostine), Etopophos (Etoposide Phosphate), Etoposide, Etoposide Phosphate, Evacet (Doxorubicin Hydrochloride Liposome), Everolimus, Evista, (Raloxifene Hydrochloride), Evomela (Melphalan Hydrochloride), Exemestane, 5-FU (Fluorouracil Injection), 5-FU (Fluorouracil—Topical), Fareston (Toremifene), Farydak (Panobinostat), Faslodex (Fulvestrant), FEC, Femara (Letrozole), Filgrastim, Fludara (Fludarabine Phosphate), Fludarabine Phosphate, Fluoroplex (Fluorouracil—Topical), Fluorouracil Injection, Fluorouracil—Topical, Flutamide, Folex (Methotrexate), Folex PFS (Methotrexate), FOLFIRI, FOLFIRI-BEVACIZUMAB, FOLFIRI-CETUXIMAB, FOLFIRINOX, FOLFOX, Folotyn (Pralatrexate), FU-LV, Fulvestrant, Gardasil (Recombinant HPV Quadrivalent Vaccine), Gardasil 9 (Recombinant HPV Nonavalent Vaccine), Gazyva (Obinutuzumab), Gefitinib, Gemcitabine Hydrochloride, GEMCITABINE-CISPLATIN, GEMCITABINE-OXALIPLATIN, Gemtuzumab Ozogamicin, Gemzar (Gemcitabine Hydrochloride), Gilotrif (Afatinib Dimaleate), Gleevec (Imatinib Mesylate), Gliadel (Carmustine Implant), Gliadel wafer (Carmustine Implant), Glucarpidase, Goserelin Acetate, Halaven (Eribulin Mesylate), Hemangeol (Propranolol Hydrochloride), Herceptin (Trastuzumab), HPV Bivalent Vaccine, Recombinant, HPV Nonavalent Vaccine, Recombinant, HPV Quadrivalent Vaccine, Recombinant, Hycamtin (Topotecan Hydrochloride), Hydrea (Hydroxyurea), Hydroxyurea, Hyper-CVAD, Ibrance (Palbociclib), Ibritumomab Tiuxetan, Ibrutinib, ICE, Iclusig (Ponatinib Hydrochloride), Idamycin (Idarubicin Hydrochloride), Idarubicin Hydrochloride, Idelalisib, Idhifa (Enasidenib Mesylate), Ifex (Ifosfamide), Ifosfamide, Ifosfamidum (Ifosfamide), IL-2 (Aldesleukin), Imatinib Mesylate, Imbruvica (Ibrutinib), Imfinzi (Durvalumab), Imiquimod, Imlygic (Talimogene Laherparepvec), Inlyta (Axitinib), Inotuzumab Ozogamicin, Interferon Alfa-2b, Recombinant, Interleukin-2 (Aldesleukin), Intron A (Recombinant Interferon Alfa-2b), Iodine I 131 Tositumomab and Tositumomab, Ipilimumab, Iressa (Gefitinib), Irinotecan Hydrochloride, Irinotecan Hydrochloride Liposome, Istodax (Romidepsin), Ixabepilone, Ixazomib Citrate, Ixempra (Ixabepilone), Jakafi (Ruxolitinib Phosphate), JEB, Jevtana (Cabazitaxel), Kadcyla (Ado-Trastuzumab Emtansine), Keoxifene (Raloxifene Hydrochloride), Kepivance (Palifermin), Keytruda (Pembrolizumab), Kisqali (Ribociclib), Kymriah (Tisagenlecleucel), Kyprolis (Carfilzomib), Lanreotide Acetate, Lapatinib Ditosylate, Lartruvo (Olaratumab), Lenalidomide, Lenvatinib Mesylate, Lenvima (Lenvatinib Mesylate), Letrozole, Leucovorin Calcium, Leukeran (Chlorambucil), Leuprolide Acetate, Leustatin (Cladribine), Levulan (Aminolevulinic Acid), Linfolizin (Chlorambucil), LipoDox (Doxorubicin Hydrochloride Liposome), Lomustine, Lonsurf (Trifluridine and Tipiracil Hydrochloride), Lupron (Leuprolide Acetate), Lupron Depot (Leuprolide Acetate), Lupron Depot-Ped (Leuprolide Acetate), Lynparza (Olaparib), Marqibo (Vincristine Sulfate Liposome), Matulane (Procarbazine Hydrochloride), Mechlorethamine Hydrochloride, Megestrol Acetate, Mekinist (Trametinib), Melphalan, Melphalan Hydrochloride, Mercaptopurine, Mesna, Mesnex (Mesna), Methazolastone (Temozolomide), Methotrexate, Methotrexate LPF (Methotrexate), Methylnaltrexone Bromide, Mexate (Methotrexate), Mexate-AQ (Methotrexate), Midostaurin, Mitomycin C, Mitoxantrone Hydrochloride, Mitozytrex (Mitomycin C), MOPP, Mozobil (Plerixafor), Mustargen (Mechlorethamine Hydrochloride), Mutamycin (Mitomycin C), Myleran (Busulfan), Mylosar (Azacitidine), Mylotarg (Gemtuzumab Ozogamicin), Nanoparticle Paclitaxel (Paclitaxel Albumin-stabilized Nanoparticle Formulation), Navelbine (Vinorelbine Tartrate), Necitumumab, Nelarabine, Neosar (Cyclophosphamide), Neratinib Maleate, Nerlynx (Neratinib Maleate), Netupitant and Palonosetron Hydrochloride, Neulasta (Pegfilgrastim), Neupogen (Filgrastim), Nexavar (Sorafenib Tosylate), Nilandron (Nilutamide), Nilotinib, Nilutamide, Ninlaro (Ixazomib Citrate), Niraparib Tosylate Monohydrate, Nivolumab, Nolvadex (Tamoxifen Citrate), Nplate (Romiplostim), Obinutuzumab, Odomzo (Sonidegib), OEPA, Ofatumumab, OFF, Olaparib, Olaratumab, Omacetaxine Mepesuccinate, Oncaspar (Pegaspargase), Ondansetron Hydrochloride, Onivyde (Irinotecan Hydrochloride Liposome), Ontak (Denileukin Diftitox), Opdivo (Nivolumab), OPPA, Osimertinib, Oxaliplatin, Paclitaxel, Paclitaxel Albumin-stabilized Nanoparticle Formulation, PAD, Palbociclib, Palifermin, Palonosetron Hydrochloride, Palonosetron Hydrochloride and Netupitant, Pamidronate Disodium, Panitumumab, Panobinostat, Paraplat (Carboplatin), Paraplatin (Carboplatin), Pazopanib Hydrochloride, PCV, PEB, Pegaspargase, Pegfilgrastim, Peginterferon Alfa-2b, PEG-Intron (Peginterferon Alfa-2b), Pembrolizumab, Pemetrexed Disodium, Perjeta (Pertuzumab), Pertuzumab, Platinol (Cisplatin), Platinol-AQ (Cisplatin), Plerixafor, Pomalidomide, Pomalyst (Pomalidomide), Ponatinib Hydrochloride, Portrazza (Necitumumab), Pralatrexate, Prednisone, Procarbazine Hydrochloride, Proleukin (Aldesleukin), Prolia (Denosumab), Promacta (Eltrombopag Olamine), Propranolol Hydrochloride, Provenge (Sipuleucel-T), Purinethol (Mercaptopurine), Purixan (Mercaptopurine), Radium 223 Dichloride, Raloxifene Hydrochloride, Ramucirumab, Rasburicase, R-CHOP, R-CVP, Recombinant Human Papillomavirus (HPV) Bivalent Vaccine, Recombinant Human Papillomavirus (HPV) Nonavalent Vaccine, Recombinant Human Papillomavirus (HPV) Quadrivalent Vaccine, Recombinant Interferon Alfa-2b, Regorafenib, Relistor (Methylnaltrexone Bromide), R-EPOCH, Revlimid (Lenalidomide), Rheumatrex (Methotrexate), Ribociclib, R-ICE, Rituxan (Rituximab), Rituxan Hycela (Rituximab and Hyaluronidase Human), Rituximab, Rituximab and, Hyaluronidase Human, Rolapitant Hydrochloride, Romidepsin, Romiplostim, Rubidomycin (Daunorubicin Hydrochloride), Rubraca (Rucaparib Camsylate), Rucaparib Camsylate, Ruxolitinib Phosphate, Rydapt (Midostaurin), Sclerosol Intrapleural Aerosol (Talc), Siltuximab, Sipuleucel-T, Somatuline Depot (Lanreotide Acetate), Sonidegib, Sorafenib Tosylate, Sprycel (Dasatinib), STANFORD V, Sterile Talc Powder (Talc), Steritalc (Talc), Stivarga (Regorafenib), Sunitinib Malate, Sutent (Sunitinib Malate), Sylatron (Peginterferon Alfa-2b), Sylvant (Siltuximab), Synribo (Omacetaxine Mepesuccinate), Tabloid (Thioguanine), TAC, Tafinlar (Dabrafenib), Tagrisso (Osimertinib), Talc, Talimogene Laherparepvec, Tamoxifen Citrate, Tarabine PFS (Cytarabine), Tarceva (Erlotinib Hydrochloride), Targretin (Bexarotene), Tasigna (Nilotinib), Taxol (Paclitaxel), Taxotere (Docetaxel), Tecentriq, (Atezolizumab), Temodar (Temozolomide), Temozolomide, Temsirolimus, Thalidomide, Thalomid (Thalidomide), Thioguanine, Thiotepa, Tisagenlecleucel, Tolak (Fluorouracil—Topical), Topotecan Hydrochloride, Toremifene, Torisel (Temsirolimus), Tositumomab and Iodine I 131 Tositumomab, Totect (Dexrazoxane Hydrochloride), TPF, Trabectedin, Trametinib, Trastuzumab, Treanda (Bendamustine Hydrochloride), Trifluridine and Tipiracil Hydrochloride, Trisenox (Arsenic Trioxide), Tykerb (Lapatinib Ditosylate), Unituxin (Dinutuximab), Uridine Triacetate, VAC, Vandetanib, VAMP, Varubi (Rolapitant Hydrochloride), Vectibix (Panitumumab), VeIP, Velban (Vinblastine Sulfate), Velcade (Bortezomib), Velsar (Vinblastine Sulfate), Vemurafenib, Venclexta (Venetoclax), Venetoclax, Verzenio (Abemaciclib), Viadur (Leuprolide Acetate), Vidaza (Azacitidine), Vinblastine Sulfate, Vincasar PFS (Vincristine Sulfate), Vincristine Sulfate, Vincristine Sulfate Liposome, Vinorelbine Tartrate, VIP, Vismodegib, Vistogard (Uridine Triacetate), Voraxaze (Glucarpidase), Vorinostat, Votrient (Pazopanib Hydrochloride), Vyxeos (Daunorubicin Hydrochloride and Cytarabine Liposome), Wellcovorin (Leucovorin Calcium), Xalkori (Crizotinib), Xeloda (Capecitabine), XELIRI, XELOX, Xgeva (Denosumab), Xofigo (Radium 223 Dichloride), Xtandi (Enzalutamide), Yervoy (Ipilimumab), Yondelis (Trabectedin), Zaltrap (Ziv-Aflibercept), Zarxio (Filgrastim), Zejula (Niraparib Tosylate Monohydrate), Zelboraf (Vemurafenib), Zevalin (Ibritumomab Tiuxetan), Zinecard (Dexrazoxane Hydrochloride), Ziv-Aflibercept, Zofran (Ondansetron Hydrochloride), Zoladex (Goserelin Acetate), Zoledronic Acid, Zolinza (Vorinostat), Zometa (Zoledronic Acid), Zydelig (Idelalisib), Zykadia (Ceritinib), and/or Zytiga (Abiraterone Acetate). The treatment methods can include or further include checkpoint inhibitors include, but are not limited to antibodies that block PD-1 (Nivolumab (BMS-936558 or MDX1106), CT-011, MK-3475), PD-L1 (MDX-1105 (BMS-936559), MPDL3280A, or MSB0010718C), PD-L2 (rHIgM12B7), CTLA-4 (Ipilimumab (MDX-010), Tremelimumab (CP-675,206)), IDO, B7-H3 (MGA271), B7-H4, TIM3, LAG-3 (BMS-986016).

### 1. Homology/Identity

It is understood that one way to define any known variants and derivatives or those that might arise, of the disclosed genes and proteins herein is through defining the variants and derivatives in terms of homology to specific known sequences. For example, SEQ ID NO: 1 sets forth a particular sequence of p53. Specifically disclosed are variants of these and other genes and proteins herein disclosed which have at least, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 percent homology to the stated sequence. Those of skill in the art readily understand how to determine the homology of two proteins or nucleic acids, such as genes. For example, the homology can be calculated after aligning the two sequences so that the homology is at its highest level.

Another way of calculating homology can be performed by published algorithms. Optimal alignment of sequences for comparison may be conducted by the local homology algorithm of Smith and Waterman Adv. Appl. Math. 2: 482 (1981), by the homology alignment algorithm of Needleman and Wunsch, J. MoL Biol. 48: 443 (1970), by the search for similarity method of Pearson and Lipman, Proc. Natl. Acad. Sci. U.S.A. 85: 2444 (1988), by computerized implementations of these algorithms (GAP, BESTFIT, FASTA, and TFASTA in the Wisconsin Genetics Software Package, Genetics Computer Group, 575 Science Dr., Madison, Wis.), or by inspection.

The same types of homology can be obtained for nucleic acids by for example the algorithms disclosed in Zuker, M. Science 244:48-52, 1989, Jaeger et al. Proc. Natl. Acad. Sci. USA 86:7706-7710, 1989, Jaeger et al. Methods Enzymol. 183:281-306, 1989 which are herein incorporated by reference for at least material related to nucleic acid alignment.

### 2. Peptides

### a) Protein Variants

As discussed herein there are numerous variants of the p53 protein that are known and herein contemplated. Protein variants and derivatives are well understood to those of skill in the art and in can involve amino acid sequence modifications. For example, amino acid sequence modifications typically fall into one or more of three classes: substitutional, insertional or deletional variants. Insertions include amino and/or carboxyl terminal fusions as well as intrasequence insertions of single or multiple amino acid residues. Insertions ordinarily will be smaller insertions than those of amino or carboxyl terminal fusions, for example, on the order of one to four residues. Immunogenic fusion protein derivatives, such as those described in the examples, are made by fusing a polypeptide sufficiently large to confer immunogenicity to the target sequence by cross-linking in vitro or by recombinant cell culture transformed with DNA encoding the fusion. Deletions are characterized by the removal of one or more amino acid residues from the protein sequence. Typically, no more than about from 2 to 6 residues are deleted at any one site within the protein molecule. These variants ordinarily are prepared by site specific mutagenesis of nucleotides in the DNA encoding the protein, thereby producing DNA encoding the variant, and thereafter expressing the DNA in recombinant cell culture. Techniques for making substitution mutations at predetermined sites in DNA having a known sequence are well known, for example M13 primer mutagenesis and PCR mutagenesis. Amino acid substitutions are typically of single residues, but can occur at a number of different locations at once; insertions usually will be on the order of about from 1 to 10 amino acid residues; and deletions will range about from 1 to 30 residues. Deletions or insertions preferably are made in adjacent pairs, i.e. a deletion of 2 residues or insertion of 2 residues. Substitutions, deletions, insertions or any combination thereof may be combined to arrive at a final construct. The mutations must not place the sequence out of reading frame and preferably will not create complementary regions that could produce secondary mRNA structure. Substitutional variants are those in which at least one residue has been removed and a different residue inserted in its place. Such substitutions generally are made in accordance with the following Tables 1 and 2 and are referred to as conservative substitutions.

TABLE 1
Amino Acid Abbreviations

| Amino Acid | Abbreviations | |
|---|---|---|
| Alanine | Ala | A |
| allosoleucine | AIle | |
| Arginine | Arg | R |
| asparagine | Asn | N |
| aspartic acid | Asp | D |
| Cysteine | Cys | C |
| glutamic acid | Glu | E |
| Glutamine | Gln | Q |
| Glycine | Gly | G |
| Histidine | His | H |
| Isolelucine | Ile | I |
| Leucine | Leu | L |
| Lysine | Lys | K |
| phenylalanine | Phe | F |
| proline | Pro | P |
| pyroglutamic acid | pGlu | |
| Serine | Ser | S |
| Threonine | Thr | T |
| Tyrosine | Tyr | Y |
| Tryptophan | Trp | W |
| Valine | Val | V |

TABLE 2
Amino Acid Substitutions
Original Residue Exemplary Conservative Substitutions,
others are known in the art.

| | |
|---|---|
| Ala | Ser |
| Arg | Lys; Gln |
| Asn | Gln; His |
| Asp | Glu |
| Cys | Ser |
| Gln | Asn, Lys |
| Glu | Asp |
| Gly | Pro |
| His | Asn; Gln |
| Ile | Leu; Val |
| Leu | Ile; Val |
| Lys | Arg; Gln |
| Met | Leu; Ile |
| Phe | Met; Leu; Tyr |
| Ser | Thr |
| Thr | Ser |
| Trp | Tyr |
| Tyr | Trp; Phe |
| Val | Ile; Leu |

Substantial changes in function or immunological identity are made by selecting substitutions that are less conservative than those in Table 2, i.e., selecting residues that differ more significantly in their effect on maintaining (a) the structure of the polypeptide backbone in the area of the substitution, for example as a sheet or helical conformation, (b) the charge or hydrophobicity of the molecule at the target site or (c) the bulk of the side chain. The substitutions which in general are expected to produce the greatest changes in the protein properties will be those in which (a) a hydrophilic residue, e.g. seryl or threonyl, is substituted for (or by) a hydrophobic residue, e.g. leucyl, isoleucyl, phenylalanyl, valyl or alanyl; (b) a cysteine or proline is substituted for (or by) any other residue; (c) a residue having an electropositive side chain, e.g., lysyl, arginyl, or histidyl, is substituted for (or by) an electronegative residue, e.g., glutamyl or aspartyl; or (d) a residue having a bulky side chain, e.g., phenylalanine, is substituted for (or by) one not having a side chain, e.g., glycine, in this case, (e) by increasing the number of sites for sulfation and/or glycosylation.

For example, the replacement of one amino acid residue with another that is biologically and/or chemically similar is known to those skilled in the art as a conservative substitution. For example, a conservative substitution would be replacing one hydrophobic residue for another, or one polar residue for another. The substitutions include combinations such as, for example, Gly, Ala; Val, Ile, Leu; Asp, Glu; Asn, Gln; Ser, Thr; Lys, Arg; and Phe, Tyr. Such conservatively substituted variations of each explicitly disclosed sequence are included within the mosaic polypeptides provided herein.

Substitutional or deletional mutagenesis can be employed to insert sites for N-glycosylation (Asn-X-Thr/Ser) or O-glycosylation (Ser or Thr). Deletions of cysteine or other labile residues also may be desirable. Deletions or substitutions of potential proteolysis sites, e.g. Arg, is accomplished for example by deleting one of the basic residues or substituting one by glutaminyl or histidyl residues.

Certain post-translational derivatizations are the result of the action of recombinant host cells on the expressed polypeptide. Glutaminyl and asparaginyl residues are frequently post-translationally deamidated to the corresponding glutamyl and asparyl residues. Alternatively, these residues are deamidated under mildly acidic conditions. Other post-translational modifications include hydroxylation of proline and lysine, phosphorylation of hydroxyl groups of seryl or threonyl residues, methylation of the o-amino groups of lysine, arginine, and histidine side chains (T.E. Creighton, Proteins: Structure and Molecular Properties, W. H. Freeman & Co., San Francisco pp 79-86 [1983]), acetylation of the N-terminal amine and, in some instances, amidation of the C-terminal carboxyl.

It is understood that one way to define the variants and derivatives of the disclosed proteins herein is through defining the variants and derivatives in terms of homology/identity to specific known sequences. For example, SEQ ID NO:1 sets forth a particular sequence of p53 protein. Specifically disclosed are variants of these and other proteins herein disclosed which have at least, 70% or 75% or 80% or 85% or 90% or 95% homology to the stated sequence. Those of skill in the art readily understand how to determine the homology of two proteins. For example, the homology can be calculated after aligning the two sequences so that the homology is at its highest level.

Another way of calculating homology can be performed by published algorithms. Optimal alignment of sequences for comparison may be conducted by the local homology algorithm of Smith and Waterman Adv. Appl. Math. 2: 482 (1981), by the homology alignment algorithm of Needleman and Wunsch, J. MoL Biol. 48: 443 (1970), by the search for similarity method of Pearson and Lipman, Proc. Natl. Acad. Sci. U.S.A. 85: 2444 (1988), by computerized implementations of these algorithms (GAP, BESTFIT, FASTA, and TFASTA in the Wisconsin Genetics Software Package, Genetics Computer Group, 575 Science Dr., Madison, Wis.), or by inspection.

The same types of homology can be obtained for nucleic acids by for example the algorithms disclosed in Zuker, M. Science 244:48-52, 1989, Jaeger et al. Proc. Natl. Acad. Sci. USA 86:7706-7710, 1989, Jaeger et al. Methods Enzymol. 183:281-306, 1989.

It is understood that the description of conservative mutations and homology can be combined together in any combination, such as embodiments that have at least 70% homology to a particular sequence wherein the variants are conservative mutations.

As this specification discusses various proteins and protein sequences it is understood that the nucleic acids that can encode those protein sequences are also disclosed. This would include all degenerate sequences related to a specific protein sequence, i.e. all nucleic acids having a sequence that encodes one particular protein sequence as well as all nucleic acids, including degenerate nucleic acids, encoding the disclosed variants and derivatives of the protein sequences. Thus, while each particular nucleic acid sequence may not be written out herein, it is understood that each and every sequence is in fact disclosed and described herein through the disclosed protein sequence. It is also understood that while no amino acid sequence indicates what particular DNA sequence encodes that protein within an organism, where particular variants of a disclosed protein are disclosed herein, the known nucleic acid sequence that encodes that protein is also known and herein disclosed and described.

It is understood that there are numerous amino acid and peptide analogs which can be incorporated into the disclosed compositions. For example, there are numerous D amino acids or amino acids which have a different functional substituent then the amino acids shown in Table 1 and Table 2. The opposite stereo isomers of naturally occurring peptides are disclosed, as well as the stereo isomers of peptide analogs. These amino acids can readily be incorporated into polypeptide chains by charging tRNA molecules with the amino acid of choice and engineering genetic constructs that utilize, for example, amber codons, to insert the analog amino acid into a peptide chain in a site specific way.

Molecules can be produced that resemble peptides, but which are not connected via a natural peptide linkage. For example, linkages for amino acids or amino acid analogs can include CH₂NH—, —CH₂S—, —CH₂—CH₂—, CH═CH— (cis and trans), —COCH₂—, —CH(OH)CH₂—, and —CHH₂SO—(These and others can be found in Spatola, A. F. in Chemistry and Biochemistry of Amino Acids, Peptides, and Proteins, B. Weinstein, eds., Marcel Dekker, New York, p. 267 (1983); Spatola, A. F., Vega Data (March 1983), Vol. 1, Issue 3, Peptide Backbone Modifications (general review); Morley, Trends Pharm Sci (1980) pp. 463-468; Hudson, D. et al., Int J Pept Prot Res 14:177-185 (1979) (—CH₂NH—, CH₂CH₂—); Spatola et al. Life Sci 38:1243-1249 (1986) (—CH H₂—S); Hann J. Chem. Soc Perkin Trans. I 307-314 (1982) (—CH—CH—, cis and trans); Almquist et al. J. Med. Chem. 23:1392-1398 (1980) (—COCH₂—); Jennings-White et al. Tetrahedron Lett 23:2533 (1982) (—COCH₂—); Szelke et al. European Appln, EP 45665 CA (1982): 97:39405 (1982) (—CH(OH)CH₂—); Holladay et al. Tetrahedron. Lett 24:4401-4404 (1983) (—C(OH)CH₂—); and Hruby Life Sci 31:189-199 (1982) (—CH₂—S—); each of which is incorporated herein by reference. A particularly preferred non-peptide linkage is —CH₂NH—. It is understood that peptide analogs can have more than one atom between the bond atoms, such as b-alanine, g-aminobutyric acid, and the like.

Amino acid analogs and analogs and peptide analogs often have enhanced or desirable properties, such as, more economical production, greater chemical stability, enhanced pharmacological properties (half-life, absorption, potency, efficacy, etc.), altered specificity (e.g., a broad-spectrum of biological activities), reduced antigenicity, and others.

D-amino acids can be used to generate more stable peptides, because D amino acids are not recognized by peptidases and such. Systematic substitution of one or more amino acids of a consensus sequence with a D-amino acid of the same type (e.g., D-lysine in place of L-lysine) can be used to generate more stable peptides. Cysteine residues can be used to cyclize or attach two or more peptides together. This can be beneficial to constrain peptides into particular conformations.

### 3. Antibodies

### (1) Antibodies Generally

The term “antibodies” is used herein in a broad sense and includes both polyclonal and monoclonal antibodies. In addition to intact immunoglobulin molecules, also included in the term “antibodies” are fragments or polymers of those immunoglobulin molecules, and human or humanized versions of immunoglobulin molecules or fragments thereof, as long as they are chosen for their ability to interact with a mutant p53 monomer such that the mutant p53 monomer is inhibited from interacting with a non-mutant p53 or otherwise inhibiting functional p53 formation and function. Antibodies that selectively bind mutant variants of p53 comprising mutations at residues K120, R283, T284, K291, K292, G293, or E294 are also disclosed. The antibodies can be tested for their desired activity using the in vitro assays described herein, or by analogous methods, after which their in vivo therapeutic and/or prophylactic activities are tested according to known clinical testing methods. There are five major classes of human immunoglobulins: IgA, IgD, IgE, IgG and IgM, and several of these may be further divided into subclasses (isotypes), e.g., IgG-1, IgG-2, IgG-3, and IgG-4; IgA-1 and IgA-2. One skilled in the art would recognize the comparable classes for mouse. The heavy chain constant domains that correspond to the different classes of immunoglobulins are called alpha, delta, epsilon, gamma, and mu, respectively.

The term “monoclonal antibody” as used herein refers to an antibody obtained from a substantially homogeneous population of antibodies, i.e., the individual antibodies within the population are identical except for possible naturally occurring mutations that may be present in a small subset of the antibody molecules. The monoclonal antibodies herein specifically include “chimeric” antibodies in which a portion of the heavy and/or light chain is identical with or homologous to corresponding sequences in antibodies derived from a particular species or belonging to a particular antibody class or subclass, while the remainder of the chain(s) is identical with or homologous to corresponding sequences in antibodies derived from another species or belonging to another antibody class or subclass, as well as fragments of such antibodies, as long as they exhibit the desired antagonistic activity.

The disclosed monoclonal antibodies can be made using any procedure which produces mono clonal antibodies. For example, disclosed monoclonal antibodies can be prepared using hybridoma methods, such as those described by Kohler and Milstein, Nature, 256:495 (1975). In a hybridoma method, a mouse or other appropriate host animal is typically immunized with an immunizing agent to elicit lymphocytes that produce or are capable of producing antibodies that will specifically bind to the immunizing agent. Alternatively, the lymphocytes may be immunized in vitro.

The monoclonal antibodies may also be made by recombinant DNA methods. DNA encoding the disclosed monoclonal antibodies can be readily isolated and sequenced using conventional procedures (e.g., by using oligonucleotide probes that are capable of binding specifically to genes encoding the heavy and light chains of murine antibodies). Libraries of antibodies or active antibody fragments can also be generated and screened using phage display techniques, e.g., as described in U.S. Pat. No. 5,804,440 to Burton et al. and U.S. Pat. No. 6,096,441 to Barbas et al.

In vitro methods are also suitable for preparing monovalent antibodies. Digestion of antibodies to produce fragments thereof, particularly, Fab fragments, can be accomplished using routine techniques known in the art. For instance, digestion can be performed using papain. Examples of papain digestion are described in WO 94/29348 published Dec. 22, 1994 and U.S. Pat. No. 4,342,566. Papain digestion of antibodies typically produces two identical antigen binding fragments, called Fab fragments, each with a single antigen binding site, and a residual Fc fragment. Pepsin treatment yields a fragment that has two antigen combining sites and is still capable of cross-linking antigen.

As used herein, the term “antibody or fragments thereof” encompasses chimeric antibodies, nanobodies, immunotoxins, and hybrid antibodies, with dual or multiple antigen or epitope specificities (including, but not limited to diabodies), and fragments, such as F(ab′)2, Fab′, Fab, Fv, scFv, VHH, and the like, including hybrid fragments. Thus, fragments of the antibodies that retain the ability to bind their specific antigens are provided. For example, fragments of antibodies which maintain mutant p53 monomer binding activity are included within the meaning of the term “antibody or fragment thereof.” Such antibodies and fragments can be made by techniques known in the art and can be screened for specificity and activity according to the methods set forth in the Examples and in general methods for producing antibodies and screening antibodies for specificity and activity (See Harlow and Lane. Antibodies, A Laboratory Manual. Cold Spring Harbor Publications, New York, (1988)).

Also included within the meaning of “antibody or fragments thereof” are conjugates of antibody fragments and antigen binding proteins (single chain antibodies).

The fragments, whether attached to other sequences or not, can also include insertions, deletions, substitutions, or other selected modifications of particular regions or specific amino acids residues, provided the activity of the antibody or antibody fragment is not significantly altered or impaired compared to the non-modified antibody or antibody fragment. These modifications can provide for some additional property, such as to remove/add amino acids capable of disulfide bonding, to increase its bio-longevity, to alter its secretory characteristics, etc. In any case, the antibody or antibody fragment must possess a bioactive property, such as specific binding to its cognate antigen. Functional or active regions of the antibody or antibody fragment may be identified by mutagenesis of a specific region of the protein, followed by expression and testing of the expressed polypeptide. Such methods are readily apparent to a skilled practitioner in the art and can include site-specific mutagenesis of the nucleic acid encoding the antibody or antibody fragment. (Zoller, M. J. Curr. Opin. Biotechnol. 3:348-354, 1992).

As used herein, the term “antibody” or “antibodies” can also refer to a human antibody and/or a humanized antibody. Many non-human antibodies (e.g., those derived from mice, rats, or rabbits) are naturally antigenic in humans, and thus can give rise to undesirable immune responses when administered to humans. Therefore, the use of human or humanized antibodies in the methods serves to lessen the chance that an antibody administered to a human will evoke an undesirable immune response.

### (2) Human Antibodies

The disclosed human antibodies can be prepared using any technique. The disclosed human antibodies can also be obtained from transgenic animals. For example, transgenic, mutant mice that are capable of producing a full repertoire of human antibodies, in response to immunization, have been described (see, e.g., Jakobovits et al., Proc. Natl. Acad. Sci. USA, 90:2551-255 (1993); Jakobovits et al., Nature, 362:255-258 (1993); Bruggermann et al., Year in Immunol., 7:33 (1993)). Specifically, the homozygous deletion of the antibody heavy chain joining region (J(H)) gene in these chimeric and germ-line mutant mice results in complete inhibition of endogenous antibody production, and the successful transfer of the human germ-line antibody gene array into such germ-line mutant mice results in the production of human antibodies upon antigen challenge. Antibodies having the desired activity are selected using Env-CD4-co-receptor complexes as described herein.

### (3) Humanized Antibodies

Antibody humanization techniques generally involve the use of recombinant DNA technology to manipulate the DNA sequence encoding one or more polypeptide chains of an antibody molecule. Accordingly, a humanized form of a non-human antibody (or a fragment thereof) is a chimeric antibody or antibody chain (or a fragment thereof, such as an sFv, Fv, Fab, Fab′, F(ab′)2, or other antigen-binding portion of an antibody) which contains a portion of an antigen binding site from a non-human (donor) antibody integrated into the framework of a human (recipient) antibody.

To generate a humanized antibody, residues from one or more complementarity determining regions (CDRs) of a recipient (human) antibody molecule are replaced by residues from one or more CDRs of a donor (non-human) antibody molecule that is known to have desired antigen binding characteristics (e.g., a certain level of specificity and affinity for the target antigen). In some instances, Fv framework (FR) residues of the human antibody are replaced by corresponding non-human residues. Humanized antibodies may also contain residues which are found neither in the recipient antibody nor in the imported CDR or framework sequences. Generally, a humanized antibody has one or more amino acid residues introduced into it from a source which is non-human. In practice, humanized antibodies are typically human antibodies in which some CDR residues and possibly some FR residues are substituted by residues from analogous sites in rodent antibodies. Humanized antibodies generally contain at least a portion of an antibody constant region (Fc), typically that of a human antibody (Jones et al., Nature, 321:522-525 (1986), Reichmann et al., Nature, 332:323-327 (1988), and Presta, Curr. Opin. Struct. Biol., 2:593-596 (1992)).

Methods for humanizing non-human antibodies are well known in the art. For example, humanized antibodies can be generated according to the methods of Winter and co-workers (Jones et al., Nature, 321:522-525 (1986), Riechmann et al., Nature, 332:323-327 (1988), Verhoeyen et al., Science, 239:1534-1536 (1988)), by substituting rodent CDRs or CDR sequences for the corresponding sequences of a human antibody. Methods that can be used to produce humanized antibodies are also described in U.S. Pat. No. 4,816,567 (Cabilly et al.), U.S. Pat. No. 5,565,332 (Hoogenboom et al.), U.S. Pat. No. 5,721,367 (Kay et al.), U.S. Pat. No. 5,837,243 (Deo et al.), U.S. Pat. No. 5, 939,598 (Kucherlapati et al.), U.S. Pat. No. 6,130,364 (Jakobovits et al.), and U.S. Pat. No. 6,180,377 (Morgan et al.).

### (4) Administration of Antibodies

Administration of the antibodies can be done as disclosed herein. Nucleic acid approaches for antibody delivery also exist. The antibodies and antibody fragments can also be administered to patients or subjects as a nucleic acid preparation (e.g., DNA or RNA) that encodes the antibody or antibody fragment, such that the patient's or subject's own cells take up the nucleic acid and produce and secrete the encoded antibody or antibody fragment. The delivery of the nucleic acid can be by any means, as disclosed herein, for example.

### 4. Pharmaceutical Carriers/Delivery of Pharmaceutical Products

As described above, the compositions can also be administered in vivo in a pharmaceutically acceptable carrier. By “pharmaceutically acceptable” is meant a material that is not biologically or otherwise undesirable, i.e., the material may be administered to a subject, along with the nucleic acid or vector, without causing any undesirable biological effects or interacting in a deleterious manner with any of the other components of the pharmaceutical composition in which it is contained. The carrier would naturally be selected to minimize any degradation of the active ingredient and to minimize any adverse side effects in the subject, as would be well known to one of skill in the art.

The compositions may be administered orally, parenterally (e.g., intravenously), by intramuscular injection, by intraperitoneal injection, transdermally, extracorporeally, topically or the like, including topical intranasal administration or administration by inhalant. As used herein, “topical intranasal administration” means delivery of the compositions into the nose and nasal passages through one or both of the nares and can comprise delivery by a spraying mechanism or droplet mechanism, or through aerosolization of the nucleic acid or vector. Administration of the compositions by inhalant can be through the nose or mouth via delivery by a spraying or droplet mechanism. Delivery can also be directly to any area of the respiratory system (e.g., lungs) via intubation. The exact amount of the compositions required will vary from subject to subject, depending on the species, age, weight and general condition of the subject, the severity of the allergic disorder being treated, the particular nucleic acid or vector used, its mode of administration and the like. Thus, it is not possible to specify an exact amount for every composition. However, an appropriate amount can be determined by one of ordinary skill in the art using only routine experimentation given the teachings herein.

Parenteral administration of the composition, if used, is generally characterized by injection. Injectables can be prepared in conventional forms, either as liquid solutions or suspensions, solid forms suitable for solution of suspension in liquid prior to injection, or as emulsions. A more recently revised approach for parenteral administration involves use of a slow release or sustained release system such that a constant dosage is maintained. See, e.g., U.S. Pat. No. 3,610,795, which is incorporated by reference herein.

The materials may be in solution, suspension (for example, incorporated into microparticles, liposomes, or cells). These may be targeted to a particular cell type via antibodies, receptors, or receptor ligands. The following references are examples of the use of this technology to target specific proteins to tumor tissue (Senter, et al., Bioconjugate Chem., 2:447-451, (1991); Bagshawe, K. D., Br. J. Cancer, 60:275-281, (1989); Bagshawe, et al., Br. J. Cancer, 58:700-703, (1988); Senter, et al., Bioconjugate Chem., 4:3-9, (1993); Battelli, et al., Cancer Immunol. Immunother., 35:421-425, (1992); Pietersz and McKenzie, Immunolog. Reviews, 129:57-80, (1992); and Roffler, et al., Biochem. Pharmacol, 42:2062-2065, (1991)). Vehicles such as “stealth” and other antibody conjugated liposomes (including lipid mediated drug targeting to colonic carcinoma), receptor mediated targeting of DNA through cell specific ligands, lymphocyte directed tumor targeting, and highly specific therapeutic retroviral targeting of murine glioma cells in vivo. The following references are examples of the use of this technology to target specific proteins to tumor tissue (Hughes et al., Cancer Research, 49:6214-6220, (1989); and Litzinger and Huang, Biochimica et Biophysica Acta, 1104:179-187, (1992)). In general, receptors are involved in pathways of endocytosis, either constitutive or ligand induced. These receptors cluster in clathrin-coated pits, enter the cell via clathrin-coated vesicles, pass through an acidified endosome in which the receptors are sorted, and then either recycle to the cell surface, become stored intracellularly, or are degraded in lysosomes. The internalization pathways serve a variety of functions, such as nutrient uptake, removal of activated proteins, clearance of macromolecules, opportunistic entry of viruses and toxins, dissociation and degradation of ligand, and receptor-level regulation. Many receptors follow more than one intracellular pathway, depending on the cell type, receptor concentration, type of ligand, ligand valency, and ligand concentration. Molecular and cellular mechanisms of receptor-mediated endocytosis has been reviewed (Brown and Greene, DNA and Cell Biology 10:6, 399-409 (1991)).

### a) Pharmaceutically Acceptable Carriers

The compositions, including antibodies, can be used therapeutically in combination with a pharmaceutically acceptable carrier.

Suitable carriers and their formulations are described in Remington: The Science and Practice of Pharmacy (19th ed.) ed. A. R. Gennaro, Mack Publishing Company, Easton, Pa. 1995. Typically, an appropriate amount of a pharmaceutically-acceptable salt is used in the formulation to render the formulation isotonic. Examples of the pharmaceutically-acceptable carrier include, but are not limited to, saline, Ringer's solution and dextrose solution. The pH of the solution is preferably from about 5 to about 8, and more preferably from about 7 to about 7.5. Further carriers include sustained release preparations such as semipermeable matrices of solid hydrophobic polymers containing the antibody, which matrices are in the form of shaped articles, e.g., films, liposomes or microparticles. It will be apparent to those persons skilled in the art that certain carriers may be more preferable depending upon, for instance, the route of administration and concentration of composition being administered.

Pharmaceutical carriers are known to those skilled in the art. These most typically would be standard carriers for administration of drugs to humans, including solutions such as sterile water, saline, and buffered solutions at physiological pH. The compositions can be administered intramuscularly or subcutaneously. Other compounds will be administered according to standard procedures used by those skilled in the art.

Pharmaceutical compositions may include carriers, thickeners, diluents, buffers, preservatives, surface active agents and the like in addition to the molecule of choice. Pharmaceutical compositions may also include one or more active ingredients such as antimicrobial agents, antiinflammatory agents, anesthetics, and the like.

The pharmaceutical composition may be administered in a number of ways depending on whether local or systemic treatment is desired, and on the area to be treated. Administration may be topically (including ophthalmically, vaginally, rectally, intranasally), orally, by inhalation, or parenterally, for example by intravenous drip, subcutaneous, intraperitoneal or intramuscular injection. The disclosed antibodies can be administered intravenously, intraperitoneally, intramuscularly, subcutaneously, intracavity, or transdermally.

Preparations for parenteral administration include sterile aqueous or non-aqueous solutions, suspensions, and emulsions. Examples of non-aqueous solvents are propylene glycol, polyethylene glycol, vegetable oils such as olive oil, and injectable organic esters such as ethyl oleate. Aqueous carriers include water, alcoholic/aqueous solutions, emulsions or suspensions, including saline and buffered media. Parenteral vehicles include sodium chloride solution, Ringer's dextrose, dextrose and sodium chloride, lactated Ringer's, or fixed oils. Intravenous vehicles include fluid and nutrient replenishers, electrolyte replenishers (such as those based on Ringer's dextrose), and the like. Preservatives and other additives may also be present such as, for example, antimicrobials, anti-oxidants, chelating agents, and inert gases and the like.

Formulations for topical administration may include ointments, lotions, creams, gels, drops, suppositories, sprays, liquids and powders. Conventional pharmaceutical carriers, aqueous, powder or oily bases, thickeners and the like may be necessary or desirable.

Compositions for oral administration include powders or granules, suspensions or solutions in water or non-aqueous media, capsules, sachets, or tablets. Thickeners, flavorings, diluents, emulsifiers, dispersing aids or binders may be desirable.

Some of the compositions may potentially be administered as a pharmaceutically acceptable acid- or base-addition salt, formed by reaction with inorganic acids such as hydrochloric acid, hydrobromic acid, perchloric acid, nitric acid, thiocyanic acid, sulfuric acid, and phosphoric acid, and organic acids such as formic acid, acetic acid, propionic acid, glycolic acid, lactic acid, pyruvic acid, oxalic acid, malonic acid, succinic acid, maleic acid, and fumaric acid, or by reaction with an inorganic base such as sodium hydroxide, ammonium hydroxide, potassium hydroxide, and organic bases such as mono-, di-, trialkyl and aryl amines and substituted ethanolamines.

### b) Therapeutic Uses

Effective dosages and schedules for administering the compositions may be determined empirically, and making such determinations is within the skill in the art. The dosage ranges for the administration of the compositions are those large enough to produce the desired effect in which the symptoms of the disorder are effected. The dosage should not be so large as to cause adverse side effects, such as unwanted cross-reactions, anaphylactic reactions, and the like. Generally, the dosage will vary with the age, condition, sex and extent of the disease in the patient, route of administration, or whether other drugs are included in the regimen, and can be determined by one of skill in the art. The dosage can be adjusted by the individual physician in the event of any counterindications. Dosage can vary, and can be administered in one or more dose administrations daily, for one or several days. Guidance can be found in the literature for appropriate dosages for given classes of pharmaceutical products. For example, guidance in selecting appropriate doses for antibodies can be found in the literature on therapeutic uses of antibodies, e.g., Handbook of Monoclonal Antibodies, Ferrone et al., eds., Noges Publications, Park Ridge, N.J., (1985) ch. 22 and pp. 303-357; Smith et al., Antibodies in Human Diagnosis and Therapy, Haber et al., eds., Raven Press, New York (1977) pp. 365-389. A typical daily dosage of the antibody used alone might range from about 1 μg/kg to up to 100 mg/kg of body weight or more per day, depending on the factors mentioned above.

### B. EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Example 1: Microchip-based Molecular Microscopy Reveals the First Structure of Full-Length p53

### a) Introduction

### (1) The Protective Power of p53 in the Nucleus

In general, the primary structure of p53 can be described in three broad regions including the N-terminal domain (NTD), the DNA-binding domain (DBD), and the C-terminal domain (CTD). Most structural studies of p53 have focused on the DBD, a stable central region of the protein that interacts with exposed DNA in the nucleus. This domain protects fragile DNA strands against the damaging effects of daily stressors, such as oxidative reagents or cellular by-products. Regulatory regions within the NTD and CTD ensure the exquisite timing of DNA repair events to avoid unintentional missteps. The NTD contains a transactivation domain that interacts with other regulatory binding partners such as MDM2, an E3-ubiquitin ligase. At the opposite end of the protein, the CTD has been reported to block the DNA-binding domain while in a latent conformation. It has also been reported that post-translational modifications (PTMs) can prevent this blocking mechanism, leaving p53 in a perpetually active state. Still, others have shown that the CTD acts in a tissue-dependent manner to promote apoptotic activity. While decades of research describe the diverse functions of p53, structural evidence to support these different states remains incomplete. Expanding the knowledge of full-length p53 in distinct functional conformations holds tremendous value for the research community. As molecular microscopy has the power to resolve flexible structures of small proteins, this technology can improve these structural deficits in the cancer field.

### (2) Structural Insights of the p53 Architecture

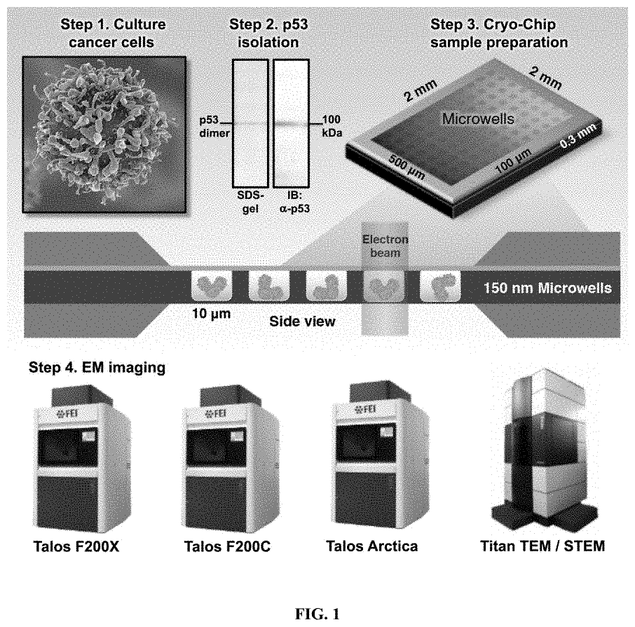

Currently, little structural information is known about the NTD and CTD regions of p53 as they are highly flexible and more challenging to resolve. Developing new approaches to illuminate full-length p53 can provide critical knowledge to better manage cellular casualties. Historically, the isolation of native proteins from human cancer cells results in low yields with limited purity. These impediments led researchers to investigate recombinant p53 constructs. While many ground-breaking insights have resulted from these analyses, one caveat of working with recombinant proteins is the risk of missing out on contextual signals that influence p53 function. To address this issue, a highly reproducible method was recently developed to capture native proteins for molecular microscopy analysis. These strategies yielded new insights for p53 monomers (˜50 kDa) and tetramers (˜200 kDa) in which the NTD and DBD could be resolved. What was missing from these initial structures was the prized CTD of p53. Hence, the structure of full-length p53 remained elusive. Here, this barrier was overcome by optimizing the microchip isolation and imaging procedures (FIG. 1). In doing so, the first structures of full-length p53 formed in human cancer cells were determined. The new structural data along with molecular modeling results supports a new model for p53 activation.

### b) Results

### (1) First Molecular Structure of the Full-Length p53 Dimer

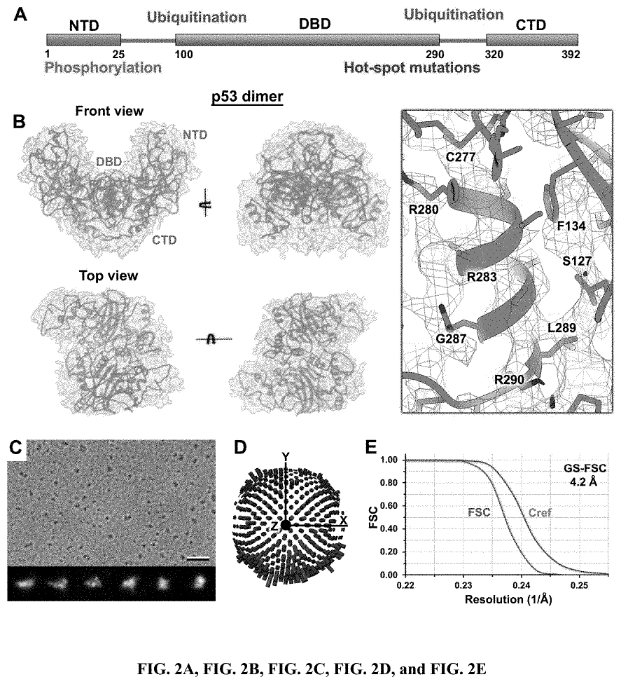

Single particle electron microscopy (EM) was used to determine 3D structures of wild-type p53 in its entirety (FIGS. 2A, 2B). Native proteins were isolated from glioblastoma multiforme cancer cells (U87MG line) using typical biochemical protocols. Prior work resulted in heterogeneous mixtures of monomers, dimers, and tetramers. Here, fractions containing enriched p53 dimers was selected for downstream structural analysis. Structures of the p53 dimers were calculated using the RELION software package and molecular modeling was performed using the UCSF Chimera software program. A model for full-length p53 was built using the PHYRE 2 protein prediction server and fit into the EM map using rigid-body refinement techniques (FIG. 2B).

Rotational views through the EM map demonstrate the quality of the model fit within the structure. The map was calculated using particles selected from EM images while enforcing C2 symmetry (˜8000 particles) during classification and reconstruction routines (FIG. 2C). The angular distribution of particle orientations was not limited in the dimeric structure that resolved to ˜4.2 Å according to validation measures in RELION, RMEASURE, and the Cref (0.5) criteria (FIG. 2D, E). The two monomers that defined the dimer interface were joined through mutual contacts in the DBD. The flexible NTD, proximal to the DBD, appeared to be stabilized by the dimer architecture. The CTD, found on the opposite end of the protein occupied the bottom half of the density map. The length of the dimer assembly is ˜70 Å as shown in the front view in FIG. 2B. A close-up view of one of the helices that defines the DBD (R280-R290) shows the presence of some side chain residues within the EM map. This level of detail is consistent with the expectation of structural resolution between 4-5 Å. Since this form of the p53 dimer lacked density to accommodate DNA strands, hence this experiment refers to state as the “inactive p53 dimer”.

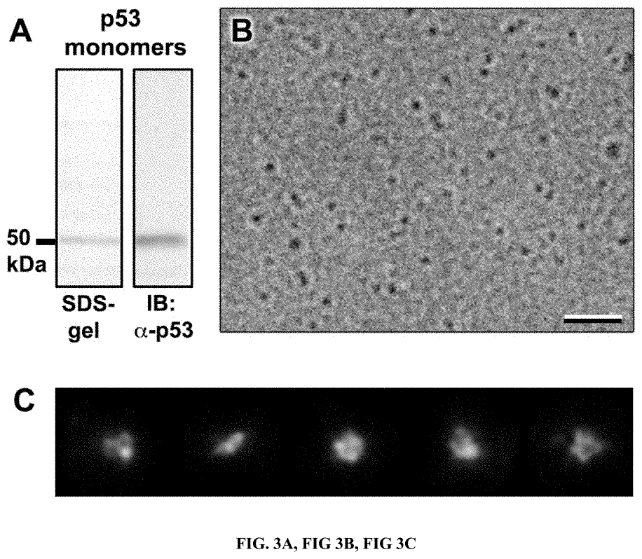

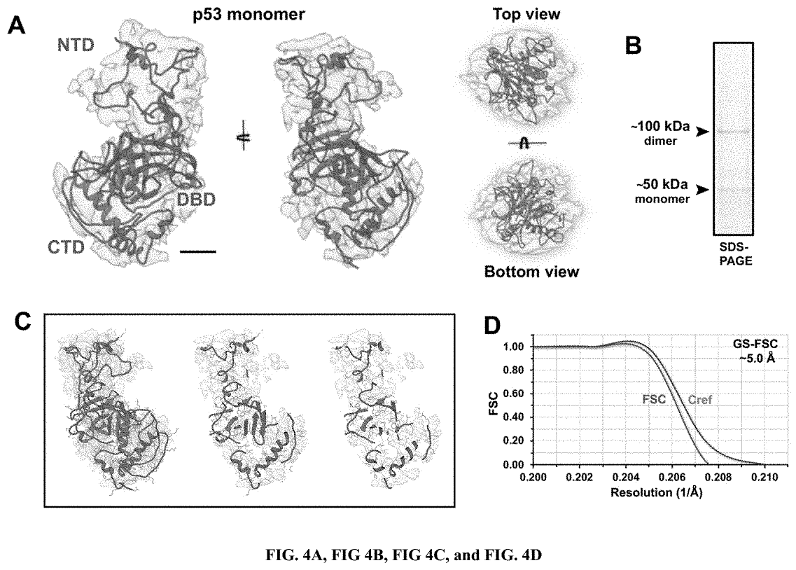

136. As a control experiment, alternative fractions enriched in p53 monomers were utilized to calculate an additional EM structure (FIG. 3). The monomers migrated at 50 kDa according to SDS-PAGE and western blot analysis, confirming their molecular mass. The same type of gels and western blots were used to characterize the p53 dimers (FIG. 2), which were surprisingly stable in denaturing gels. The EM map (˜5 Å) showed features consistent with individual monomers that comprised the p53 dimer structure (FIG. 4).

### (2) Inactive p53 Assemblies Limit DNA Engagement

The overall structure of the inactive dimers presents a “crossed” architecture.

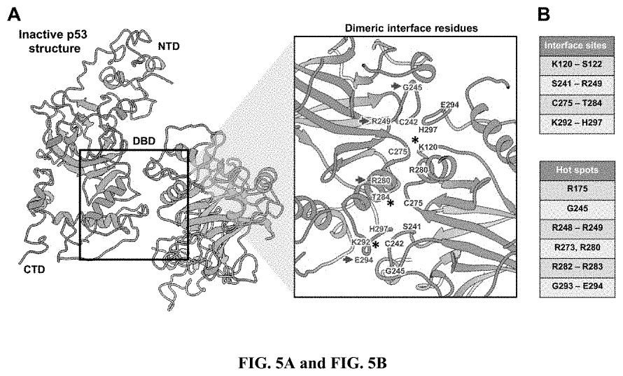

Within this motif, one monomer is vertically positioned with the NTD at the top, followed by the DBD, and CTD. The second monomer is positioned perpendicular lengthwise to the first monomer of the structure and the compact nature of the association is displayed with space-filled rendering in FIG. 5A. The interface region of the inactive p53 dimer spans the sequences: K120-S122, S241-R249, C275-T284, and K292-H297 (FIG. 5B). The interactions that mediate the connection between the two monomers include a combination of complementary charged residues and potential hydrogen bonding effects. According to the crystal structure of the DBD bound to DNA (pdb code, 2AC0), cysteines in this vicinity coordinate Zn²⁺ ions through their sulfhydryl groups. This coordination helps stabilize the DBD in its DNA-bound form of p53. While the modeling results highlight many residues that bridge the monomers, not all of the amino acids directly mediate protein-protein contacts. Surrounding residues can provide structural integrity to maintain the DBD, thus playing a supporting role for the interacting residues.

Other studies have documented key hot spot mutations within the DBD. These single point mutations often result in changes at the single amino acid level. Hot spot mutations that fall within the inactive dimer interface or are adjacent to the interface region are shown in FIG. 5C. These mutations include arginine residues (R175, R248-249, R273, R280, R282-R283) along with glycine (G245, G293) and glutamate (E294). As single mutations in these amino acids can lessen collective DBD interactions with DNA, they have been heavily linked to human cancer. The new structural information for the interface residues also implicates a potential role for PTMs.

Three points within the interface that need to be further explored biochemically include K120, T284, and K292. The two lysine residues (K120, K292) are sites for ubiquitination while the threonine site (T284) can be phosphorylated. Acetylation of K120 has also been reported and has been linked to the initiation of apoptotic pathways. Interestingly, this modification can compete with ubiquitination from another well-known regulatory protein, MDM2, to stabilize p53. Depending upon the level of accessibility of these residues within the inactive dimer, PTMs can play an unforeseen role in releasing the sequestered dimers from an inactive form to an active conformation, capable of binding DNA. These modifications can enable p53 to exist at high concentrations in the nucleus, without engaging DNA until appropriately triggered by other cellular signals.

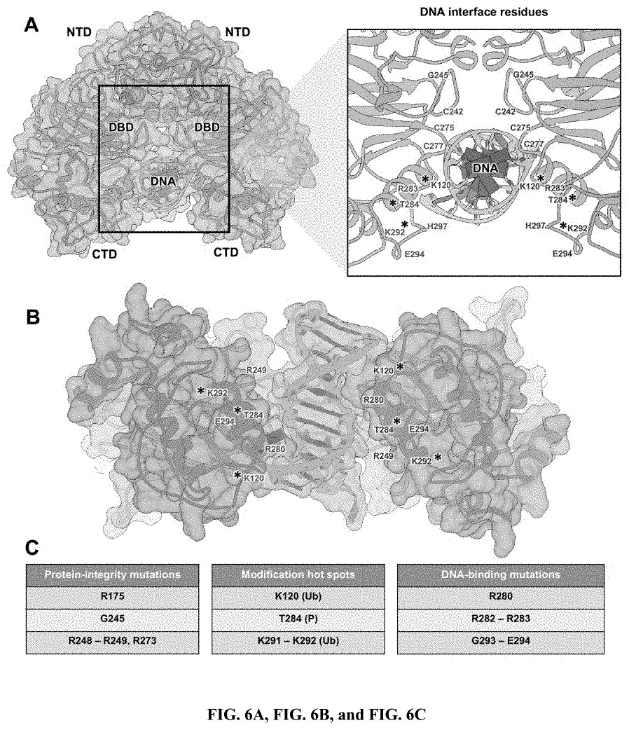

To better understand conformational changes to p53 during DNA binding, the monomer models that comprised the dimer structure weRE first separated. the Chimera software package was used to place the full-length p53 models upon a fragment of double-stranded DNA. The previously determined structure of the DBD bound to DNA (pdb code, 2AC0) served as a suitable template for this exercise. The DBD of each full-length monomer was superimposed upon the DBD of the crystal structure, with no changes to the DNA helix. The new model contained two full-length p53 models and a DNA fragment to represent the activation state of repair (FIG. 6A). The new complex model did not encounter any clashes and protein-DNA contacts were preserved as specified in the crystal structure. In contrast to the crossed architecture of the inactive p53 dimer, the two monomers in the active model were positioned in parallel upon the DNA strand. Using this new model, changes were interpreted in the dimer interface residues upon p53 binding to DNA.

In comparing the dimer models, it was found that many of the same amino acids that engaged the DNA fragment were involved in creating the interface of the inactive structure (FIG. 6B). Taking a closer look at these residues in the DNA-bound model, the damaging effects of p53 mutations were assessed. For example, common mutations that were adjacent to the DNA binding site but do not directly interact with the helical backbone were classified as protein integrity mutations (R175, G245, R248-R249, R273). Whereas mutations that effected potential PTM sites were considered modification hot spots (K120, T284, K291-K292). Finally, changes in residues that directly contacted the helical backbone were referred to as DNA-binding mutations (R280, R282-R283, G293-E294). These classifications are listed in FIG. 6C to complement their structural mapping within the active dimer models.

### (3) Conformational Changes Support DNA Binding Events

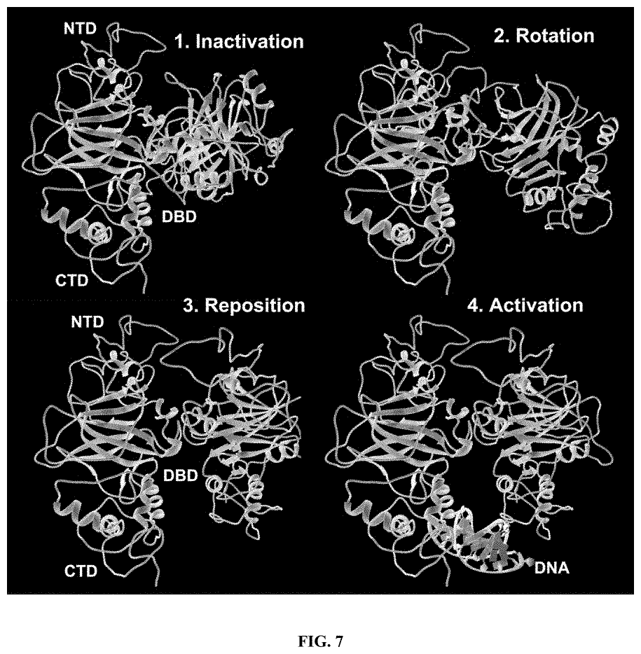

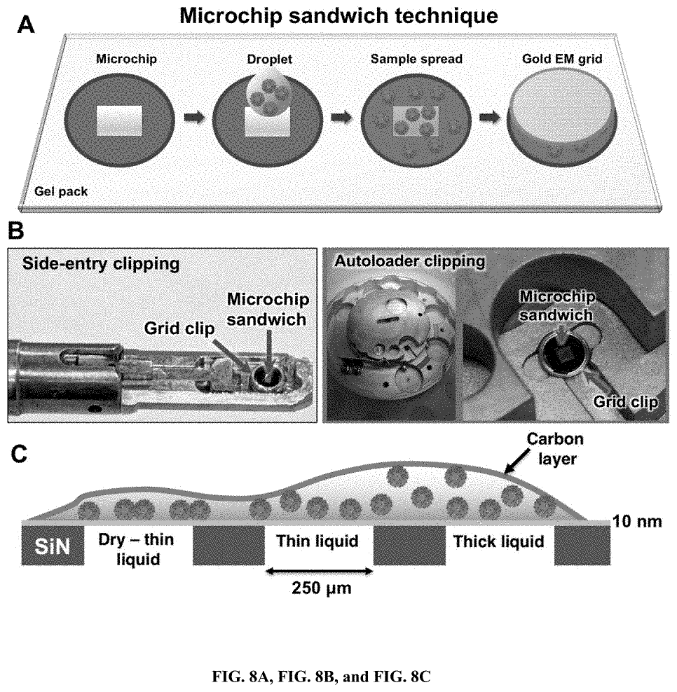

Conformational changes needed to transition from the inactive dimer to the active DNA-bound complex are highlighted in FIG. 7. The path toward activation involves four steps: 1) inactivation; 2) rotation; 3) reposition; 4) activation. Inactivation is the sequestration of p53 monomers in the crossed conformation. Rotation involves one of the monomers released from the crossed pattern towards a more parallel configuration with the other monomer (FIG. 7, cyan is rotating). Reposition is the action of one monomer assuming the parallel configuration with respect to the other more stationary protein unit (FIG. 7, cyan is parallel to green). Finally, activation occurs when both monomers assume a parallel configuration to interact with a strand of DNA. As an alternative mechanism, individual monomers that are not sequestered can also interact with DNA at times of increased cellular stress, such as oxidative damage. These interactions involve the addition of K63-linked ubiquitin moieties to monomeric p53.

Following DNA repair, p53 dimers can be liberated from the DNA helix to reform the inactive state. Re-establishing this inactive conformation can serve to sequester the freed p53 dimers for on-demand DNA damage response. The dimensions of inactive dimers are too large to exit the nucleus through the nuclear pore complex. Therefore, maintaining inactive p53 dimers in the vicinity of fragile DNA strands can provide an added layer of protection for the genome. Although additional experiments are needed to test the reversibility of the proposed mechanism and rate of conversion, this paradigm is well-supported by the new structural data and molecular modeling experiments.

### (4) Validation of the p53 Monomer Structure

To better understand the monomer constituents of the inactive dimer, robust 3D classification routines were used in the RELION software package to separate individual structures. This computational scheme has been utilized to delineate p53 monomers from tetramers in recent work. The new density map calculated for the p53 monomer structure permitted us to fit the model within the envelope. Previous EM structures only accommodated the NTD and the DBD. Additional density present for the CTD was delineated in the new structure (FIG. 4A). The presence of the monomer and dimer were confirmed using SDS-PAGE analysis (FIG. 4B). P53 monomers migrated at ˜50 kDa while dimers migrated at ˜100 kDa. The flexible nature of the NTD is evident by the extra unoccupied density in the top half of the map, which was also seemingly less resolved than the lower half containing the helical-rich DBD and CTD (FIG. 4C). The total length of the monomer structure was ˜70 Å, and the structure was resolved to ˜5 Å according to RELION, RMEASURE, and the Cref (0.5) criteria (FIG. 4D)

While p53 dimers are thought to be ubiquitinated when bound to damaged DNA, p53 monomers are also subject to a host of post-translational modifications. Therefore, this study sought to determine whether mono-ubiquitination was possible based on the new models. There was no apparent density to support ubiquitin attachments in the EM map of the monomers. Western blots probing for mono-ubiquitinated monomers did not show reliable signal in the region close to ˜50 kDa. These results are in good agreement with prior findings that p53 ubiquitination likely occurs upon DNA binding as a signal for repair.

### (5) P53 Dimers Can Occupy Inactive and Active States

Here this study provides new structural evidence for a dimeric form of p53 in its native state and free of DNA. This inactive conformation was mediated by residues in the DBD also involved in nucleotide binding. Cancer-related mutations were mapped in the dimer interface region identifying key points involved in protein stability, PTMs, and DNA engagement. Molecular modeling procedures also allowed for the development of a new model for full-length p53 dimers engaging DNA. The manner in which the inactive to active transition occurs for p53 dimers need further biochemical assessment and future studies are aimed at delineating these steps.

Considering there are overlapping sites for point mutations and PTMs in the DBD, this study posits that modifications to the dimer interface region can be required to release p53 for DNA engagement. The use of PTMs to accomplish this goal adds a layer of complexity to protein regulatory events. For example, ubiquitination is a known modifier of transcription factors and DNA repair proteins. Ubiquitination and at a single site or at multiple sites in p53 can increase DNA-binding affinity by stabilizing intermolecular interactions. PTMs are also related to increased nuclear export and the viability of p53 in cells. Taken together, the current results, provide an exciting new view for protein-DNA interactions, introducing a new prequel structure of full-length p53.

### c) Methods

### (1) Biochemical Isolation of p53 and EM Sample Preparation

The biochemical extraction procedure is as follows. Briefly; U87MG glioblastoma cells (ATCC) were cultured under standard growth conditions. Their cytoplasmic and nuclear fractions were separated using the NE-PER kit (Thermo Fisher Scientific). The soluble nuclear fractions (˜1 mg/mL) collected were incubated with nickel-nitrilotriacetic acid (Ni-NTA) agarose beads (Qiagen) in 20 mM HEPES buffer (pH 7.2; 20 mM HEPES, 140 mM NaCl, 2 mM CaCl₂, 2 mM MgCl₂, and 5 nM imidazole) for 1 hour at 4° C. The same buffer, supplemented with 60 mM imidazole, was used to elute complexes. Fractions were evaluated with SimplyBlue-stained SDS-PAGE gels. Western blots were probed with primary monoclonal antibodies against the p53 NTD (DO-1; Santa Cruz Biotechnology, sc-126). For cryo-EM sample preparation, Silicon Nitride microchips (Protochips, Inc.) containing integrated microwells was used. The microchips were coated with Ni-NTA lipid monolayers that served to enrich and purify p53 assemblies. The microchips were 2 mm×2 mm in the x- and y-dimension and 0.3 mm in the z-dimension. Imaging windows (10 μm×10 μm) were etched as an array into the window frames (500 μm×200 μm). The thickness of each imaging window was ˜30 nm. Protein samples spread evenly over the imaging windows and the microchips fit into commercially-available side-entry specimen holders.

### (2) EM Data Collection and Image Processing

Frozen microchips containing p53 were loaded into a Gatan 626 side-entry holder (Gatan, Inc.) and inserted into a Talos F200 TEM (ThermoFisher Scientific) operating at 200 kV. Images were collected under low dose conditions (<5 electrons/Å²/s and 1-second exposures) using a CETA camera (ThermoFisher Scientific) with a pixel spacing of 14-μm. The nominal magnification was ˜142,000× and the pixel size at the specimen level was ˜0.98 Å/pixel. Single particle imaging processing was performed using the RELION software package. Monomer and dimer reconstructions were refined for 25 iterations. The full-length p53 model was produced using the PHYRE2 Protein Fold Recognition Server. The model was fit into the EM maps using rigid-body refinement procedures in the Chimera software package. The p53 monomer (˜5 Å) and dimer maps (˜4.2 Å) accommodated the full model and no clashes were introduced in the final structure. The individual p53 monomer length was consistent with the length of individual NTD, DBD, and CTD (˜70 Å in total). The dimer model revealed no characteristic density to accommodate a double-stranded DNA helix.

### (3) Molecular Modeling

The primary sequence of wild-type P53 was uploaded to the PHYRE2 protein fold recognition server. One consistent output model resulted from the server. This model was fit into the EM density maps as a single rigid body for both the p53 dimer and monomer structures. To interpret the dimer structure, the DBD region of the new model was superimposed over the DBD for the crystal structure (pdb code, 2AC0).

### 2. Example 2: High-Resolution Imaging of Human Cancer Proteins Using Microprocessor Materials

It has been 40 years since the discovery of the tumor suppressor protein p53, often referred to as the “guardian of the genome”. The multi-faceted roles of p53 range from cell cycle arrest to DNA repair and apoptosis. As these essential duties become deregulated at the molecular level, disease ensues in vulnerable cells and tissues. Errors in p53 function are implicated in approximately half of all human cancers. Curiously, the molecular architecture of p53 remains a mystery. This lack of knowledge presents barriers to understanding the physical properties of p53 for rational pharmacological applications.

The primary structure of p53 can be described in three broad regions including the N-terminal domain (NTD), the DNA-binding domain (DBD), and the C-terminal domain (CTD). Most studies of p53 have focused on the DBD, a stable central region of the protein that interacts with genomic material in the cell's nucleus. This domain binds to specific DNA regions to spur the production of protective factors that guard against daily stressors, such as cellular by-products or oxidative damage. Regulatory regions within the NTD and CTD ensure the exquisite timing of DNA binding events to avoid unintentional missteps. It has also been reported that post-translational modifications (PTMs) can influence p53 function, potentially locking it in a particular conformational state or perpetuating apoptosis. While decades of research describe the diverse functions of p53, structural evidence to support these different states remains incomplete. Expanding the knowledge of full-length p53 in distinct conformations holds tremendous value for the research community.

Historically, isolating native proteins such as p53 from cancer cells has resulted in low yields with limited purity. These challenges led researchers to investigate recombinant protein constructs. While many ground-breaking insights have resulted from these analyses, a limitation of recombinant proteins is the risk of missing contextual signals that influence native function. Equally important, cryo-Electron Microscopy (EM) structural studies of small proteins are limited, in part, to sample preparation procedures that employ reticulated substrates. For instance, cryo-EM vitrification procedures that employ face-on blotting techniques tend to remove small proteins, such as p53, which can also accumulate on the adjacent carbon matrix. Small proteins positioned on thick carbon or gold substrates do not yield an optimal signal-to-noise ratio.

To address these ongoing challenges in the field, this study employed a highly reproducible method that uses functionalized materials to capture native p53 assemblies for high-resolution analysis. Silicon nitride (SiN)-based microprocessor chips, or microchips, provide pristine, flat surfaces and reliable physical properties. Their ability to perform under extreme temperature conditions also makes them an ideal substrate for bioelectronic applications. Apertures composed of SixNx are commonly used in electron-based imaging applications and their role in high-resolution studies is rapidly emerging due to the popularity of micro-electromechanical systems (MEMS).

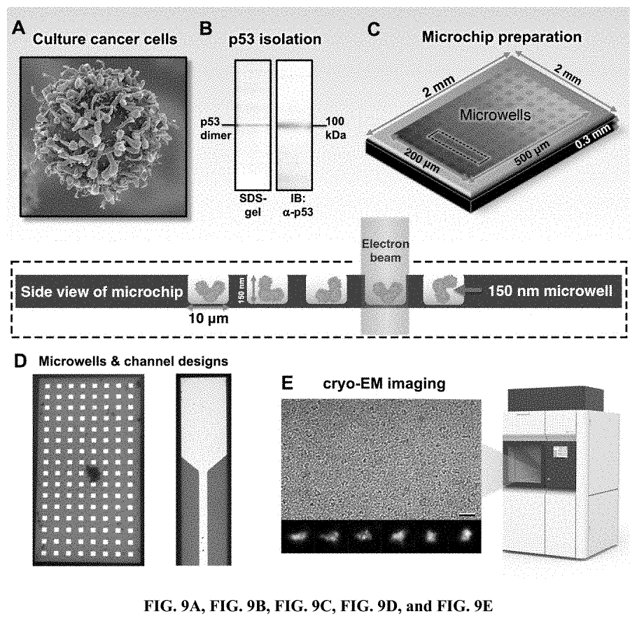

In this current work, SiN-based substrates were utilized to overcome the limitations of studying native p53 assemblies derived from human cancer cells (FIGS. 9A and 9B). This study demonstrated that functionalized microchips retained low-molecular weight proteins during face-on blotting steps, enabling the assessment of protein complexes from nuclear extracts. Results provided the first full-length structures of p53 proteins formed in primary brain tumors. In combination with molecular modeling experiments, the data supports new molecular insights for p53 activation.

SiN microchips for cryo-EM applications. Notably, attempts to use any holey carbon substrates or patterned gold grids for cryo-EM sample preparation failed to produce specimens having p53 particles in the holes of the grids. Some p53 particles were found on the carbon substrate adjacent to the holes, but they were difficult to identify. In the cryo-EM field, it is a common practice to place thin carbon films or graphene layers over holey carbon as a sample preparation technique. This technique is the carbon-based equivalent to producing microwells. It can be time consuming, inconsistent, and there is no commercially available source for holey grids having thin carbon films. Hence, reproducibility in sample production varies across EM facilities depending upon the quality and thickness of carbon film coatings.

This study found that an alternative, highly reproducibly approach was to use commercially available Silicon Nitride (SiN)-based microchips (Protochips, Inc.; SiMPore, Inc). Pristine microchips can be fabricated and etched to contain a variety of imaging widows, suitable for electron beam penetrance. Examples include integrated microwells or flow channels (FIGS. 9C and 9D) that promote particle capture and retention during specimen preparation. In comparison to traditional metal foils, microchip substrates are more physically reinforced and customizable in terms of functionalization. For the purposes of this study, SiN microchips were coated with nickel-nitrilotriacetic acid (Ni-NTA) films to enrich for native p53 assemblies from biochemical preparations. Functionalized microchips have been used to prepare a variety of soft materials and biological samples for EM analysis, ranging from liposomes and drug formulations to human viruses. The square-framed microchips were 2 mm×2 mm in the x- and y-dimensions and ˜0.3 mm in the z-dimension. Imaging arrays contained etched microwells or channels ranged from 500 μm×100 μm to 500 μm×200 μm. Individual microwells were 10 μm×10 μm in x- and y- and accommodated a liquid thickness of 150 nm. As protein samples are incubated with the microchips, individual particles flow along the applied surfaces and adhere to functionalized regions. This configuration offers a ˜10-fold greater imaging landscape than holey-carbon substrates. The square microchips fit easily into side-entry specimen holders (Protochips, Inc.) while thinner microchips (Simpore, Inc) are suitable for autoloader devices that work with the Titan Krios.

For the current studies, aliquots of enriched p53 fractions containing either monomers or dimers were prepared in buffer solution (20 mM HEPES, pH 7.5; 150 mM NaCl, 10 mM MgCl₂, 10 mM CaCl₂) and incubated with Ni-NTA coated microchips. Samples were vitrified in liquid ethane and images of frozen-hydrated specimens were collected using a CETA camera (Thermo Fisher Scientific) integrated in an Talos F200C TEM (Thermo Fisher Scientific) operating at 200 kV. Images were acquired under low dose conditions (˜5 electrons/Å²/sec) at a nominal magnification of 142,000× with a final sampling of 0.98 Å/pixel (FIG. 9E, FIG. 3, Table 3).

TABLE 3
Cryo-EM data collection, refinement, and model validation.

| | p53 monomer | p53 dimer |
|---|---|---|
| Data collection | | |
| Microscope | TFS Talos F200C | TFS Talos F200C |
| Voltage (kV) | 200 | 200 |
| Camera | CETA | CETA |
| Magnification | 142,000 | 142,000 |
| Pixel size (Å/pixel) | 0.98 | 0.98 |
| Exposure rate (e⁻/pixel/s) | 5 | 5 |
| Defocus range (microns) | −1 to −5 | −1 to −5 |
| Total images collected | 300 | 300 |
| Reconstruction parameters | | |
| Final number of particles | 8,000 | 8,000 |
| Symmetry group | C1 | C2 |
| Map resolution (Å) | | |
| (0.143 cutoff) | 5.0 | 4.2 |
| Map sharpening B factor (Å²) | −50 | |
| Model refinement/validation | | |
| Refinement packages | PHENIX/ISOLDE | |
| Real or reciprocal space | Real/Real | |
| Amino acids | 393 | |
| Resolution cutoff | 4.0 | |
| MolProbity score | 1.03 | |
| Clash score | 0.50 | |
| Ramachandran | | |
| Favored (%) | 94.88 | |
| Outliers (%) | 0.00 | |
| Rotamer outliers | 0.00 | |
| C-beta deviations | 0 | |
| Bad bonds | 0/3277 | |
| Bad angles | 9/4272 | |
| Rama-Z | −1.47 | |

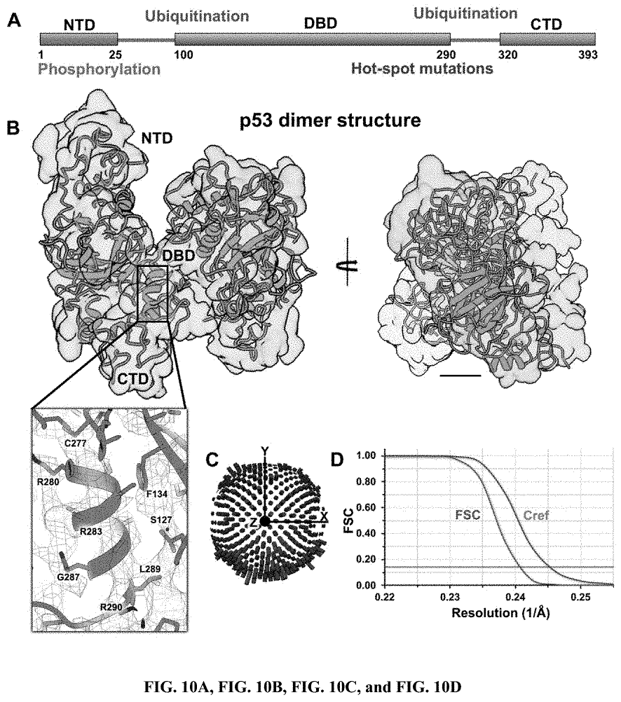

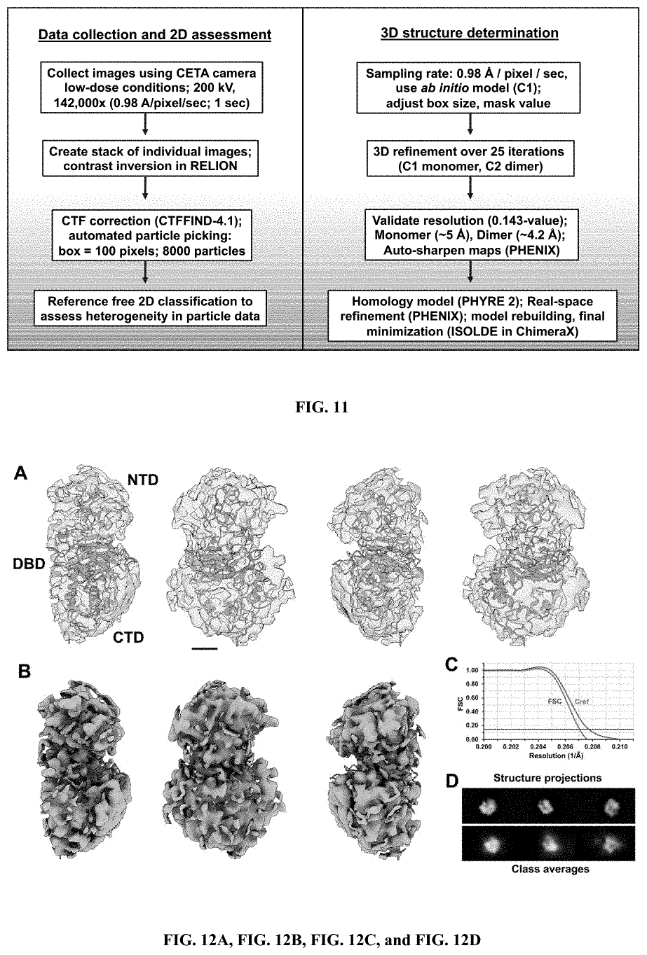

Molecular structures of full-length p53. Single particle image processing protocols were used to determine structures of wild type p53 in its entirety (FIG. 10A, 10B; FIG. 11). Native proteins were isolated from glioblastoma multiforme cancer cells (U87MG line) using previously described protocols (Experimental Section). Prior work resulted in heterogeneous mixtures of monomers, dimers, and tetramers. Here, fractions containing separated p53 monomers and dimers were used for downstream image processing procedures. P53 structures were calculated using the RELION software package and molecular modeling was performed using the PHENIX and ISOLDE programs. An initial model for full-length p53 was produced using the PHYRE 2 protein prediction server. The structure was rebuilt and refined into the p53 monomer map using rigid-body refinement and molecular dynamics/flexible fitting routines (FIG. 12). Models of two monomers were fit into the p53 dimer map, guided by segmentation routines implemented in UCSF ChimeraX. The fit models were refined in the map using the ISOLDE program (FIG. 10B). The p53 dimer structure was calculated while enforcing C2 symmetry (˜8000 particles) during refinement and reconstruction routines. The angular distribution of particle orientations was not limited in the structure that resolved to ˜4.2 Å according to RELION, RMEASURE, and the Cref (0.5) criteria (FIGS. 10C, 10D; Table 3).

The p53 dimer interface showed mutual contacts in the DBD, which was situated structurally between the NTD and CTD domains. The flexible NTD also appeared to be stabilized by the dimer architecture. The CTD, found on the opposite end of the protein from the NTD, occupied the bottom portion of the density map. The length of the dimer assembly was ˜70 Å, shown in FIG. 10B, left panel. A close-up view of a helical region in the DBD (R280-R290) shows the presence of some side chain residues within the EM map. This level of detail is consistent with the expectation of structural resolution between 4-5 Å. Since this form of the p53 dimer lacked density to accommodate double-stranded DNA helices, it was refereed as the “inactive state”.

SDS-PAGE and western blot analysis independently validated the presence of p53 dimers with a molecular mass of ˜100 kDa (FIG. 9B). The fact that the dimeric state was maintained during electrophoresis speaks to its stability in our preparations. Separate fractions containing p53 monomers migrated at 50 kDa according to denaturing gels and western blot analysis (FIG. 3). The p53 monomer structure (˜5 Å) was calculated separately from the dimer structure and showed features consistent with each monomer portion that comprised the dimer map. Moreover, the microchip preparation methods assisted in the successfully production of p53 oligomer samples suitable for high-resolution structural analysis.

Inactive p53 assemblies limit DNA engagement. The overall structure of the p53 dimers in the inactive conformation presented a “crossed” architecture. Within this configuration, one monomer is vertically positioned with the NTD at the top, followed by the DBD, and CTD. The second monomer is positioned perpendicular lengthwise to the first monomer of the structure and the compact nature of the association is displayed in FIG. 5A. The interface region of the inactive dimer spans the sequences: K120-S122, S241-R249, C275-T284, and K292-H297 (FIG. 5B). The interactions that mediate the connection between the two monomers includes a combination of complementary charged residues and potential hydrogen bonding effects. According to the crystal structure of the DBD bound to DNA (pdb code, 2AC0), cysteines in this vicinity coordinate Zn²⁺ ions through their sulfhydryl groups. This coordination helps stabilize the DBD in the DNA-bound form of p53. While these modeling results highlight many residues that bridge the monomers, not all of the amino acids directly mediate protein-protein contacts. Surrounding residues may provide structural integrity to maintain the DBD, thus playing a supporting role for the interacting residues.

Other studies have documented key hot spot mutations within the DBD. These single point mutations often result in changes at the single amino acid level. Hot spot mutations that fall within the inactive dimer interface or are adjacent to the interface region are shown in FIG. 5C. These mutations include arginine residues (R175, R248-249, R273, R280, R282-R283) along with glycine (G245, G293) and glutamate (E294). As single mutations in these amino acids may lessen collective DBD interactions with DNA, they have been heavily linked to human cancer. The new structural information for the interface residues also implicates a potential role for PTMs.

Three points within the interface that need to be further explored biochemically include K120, T284, and K292. The two lysine residues (K120, K292) are potential sites for ubiquitination while the threonine site (T284) may be phosphorylated. Acetylation of K120 has also been reported and has been linked to the initiation of apoptotic pathways. This modification can compete with ubiquitination from another well-known regulatory protein, MDM2, to stabilize p53. Depending upon the level of accessibility of these residues within the inactive dimer, PTMs may play an unforeseen role in releasing the sequestered dimers from an inactive form to an active conformation, capable of binding DNA. These modifications can enable p53 to exist at high concentrations in the nucleus, without engaging DNA until appropriately triggered by other cellular signals.

Conformational changes support DNA binding events. To better understand conformational changes to p53 during DNA binding, this study first separated the monomer models that comprised the dimer structure. The Chimera software package was then used to place full-length p53 models upon a fragment of double-stranded DNA. The previously determined structure of the DBD bound to DNA (pdb code, 2AC0) served as a suitable template for this exercise. The DBD of each full-length monomer was superimposed upon the crystal structure of the DBD with no changes to the DNA helix. The model contained two full-length monomers and a DNA fragment to represent the p53 active state (FIG. 6A).

The complex model did not encounter any clashes and protein-DNA contacts were preserved as specified in the crystal structure. In contrast to the inactive p53 dimer, the two monomers in the active model were positioned in parallel upon the DNA strand. Using this new model, changes in the dimer residues were interpreted as upon p53 binding to DNA. In comparing the dimer models, it was found that many of the same amino acids that engaged the DNA fragment were involved in creating the interface of the inactive structure (FIG. 6B).

Taking a closer look at these residues in the DNA-bound model, the damaging effects of p53 mutations were assessed. For example, common mutations that were adjacent to the DNA binding site but do not directly interact with the helical backbone, were classified as protein integrity mutations (R175, G245, R248-R249, R273). Whereas mutations that affected potential PTM sites were considered modification hot spots (K120, T284, K291-292). Finally, changes in residues that directly contacted the helical backbone were referred to as DNA-binding mutations (R280, R282-R283, G293-E294). These classifications are listed in FIG. 6C to complement their structural mapping within the active dimer models.

P53 dimers can occupy inactive and active states. While it is now known that p53 can assume an apo- or DNA-bound form, a working hypothesis has been developed to describe potential conformational changes needed to transition from the inactive dimer to the active form (FIG. 7). This working model involves four steps: 1) inactivation; 2) rotation; 3) reposition; 4) activation. Inactivation is the sequestration of p53 monomers in the crossed conformation. Rotation involves one of the monomers released from the crossed pattern towards a more parallel configuration with the other monomer (FIG. 7, blue is rotating). Reposition is the action of one monomer assuming the parallel configuration with respect to the other more stationary protein unit (FIG. 7, blue is parallel to green). Finally, activation occurs when both monomers assume a parallel configuration to interact with a strand of DNA. As an alternative mechanism, individual monomers that are not sequestered may also interact with DNA at times of increased cellular stress, such as oxidative damage. These interactions involve the addition of K63-linked ubiquitin moieties to monomeric p53.

Following DNA repair, p53 dimers can be liberated from the DNA helix to reform the inactive state. Re-establishing this inactive conformation can serve to sequester the freed p53 dimers for on-demand DNA damage response. The dimensions of inactive dimers are too large to exit the nucleus through the nuclear pore complex. Therefore, maintaining inactive p53 dimers in the vicinity of fragile DNA strands may provide an added layer of protection for the genome. Although additional experiments are needed to test the reversibility of the proposed mechanism and rate of conversion, this paradigm is well-supported by the new structural data and molecular modeling experiments.

Using specialized microchip designs and high-resolution instruments, this provides new structural evidence for a dimeric form of p53 in its native state and free of DNA. This inactive conformation was mediated by residues in the DBD also involved in nucleotide binding. Covalent bonding likely facilitated interactions, as stable p53 dimers were readily identified by SDS-PAGE and western blots. These observations are consistent with the elegant kinetic work done by the Fersht team, who demonstrated that un-ligated p53 existed predominantly as dimers in cellular fractions. Others have shown that the biogenesis of p53 entails the co-translation of dimers, which form tetramers in response to cellular signals. The structural results presented here corroborate these findings. In addition, cancer-related mutations were mapped in the dimer interface, identifying key points for protein stability, PTMs, and DNA binding. Molecular modeling procedures improved the current knowledge of how full-length p53 dimers can engage DNA.

Considering there are overlapping sites for point mutations and PTMs in the DBD, it is posited that modifications to the dimer interface region can be required to release inactive p53 for DNA engagement. Likewise, mutations in the dimer interface can also stabilize p53 monomers to preclude robust dimer formation and negatively impact DNA repair events. The use of PTMs to accomplish this goal adds a layer of complexity to protein regulatory events. For example, ubiquitination is a known modifier of transcription factors and DNA repair proteins. Ubiquitination and at a single site or at multiple sites in p53 may increase DNA-binding affinity by stabilizing intermolecular interactions. PTMs are also related to increased nuclear export and the viability of p53 in cells. Taken together, the current results, provide an exciting novel view for protein-protein interactions, introducing a prequel structure of full-length p53. Equally important, there is great value in adopting microchip substrates into current imaging workflows. First, the microprocessor materials have the unique advantage of allowing for novel windowing shapes while remaining amenable to cryo-EM conditions. Their adaptability along with opportunities for functionalization may serve to increase protein capture steps that benefit downstream image processing procedures. Second, silicon-based systems are cheaper and simpler to design than other microprocessor substrates. TEM characterization of the microchips themselves is an important step for quality assurances related to the production of computer consumables.

Finally, SiN is an up-and-coming biomaterial of interest in the research community. When compared to commonly used orthopedic materials, SiN is superior at avoiding adverse responses that enhance inflammatory cytokine release. Although the presented structural experiments are not influenced by immunological responses, there are additional advantages to using SiN to avoid the aggregation or misfolding of native proteins. The use of the microwell-integrated microchips can serve to sequester proteins away from the damaging forces encountered at the air-water interface. Protecting fragile molecules by sequestering them in the depths of the microwells leads to fewer bad particles present in EM images, a current limitation in the use of conventional reticulated substrates. Increasing the number of high-quality particles per image results in improved statistical throughput during post-processing steps. In addition, the enhanced contrast that is achievable with SiN-based specimens may offer better spatial resolution for biological structures, while requiring fewer particles per reconstruction. This feature is particularly useful when working with small protein (<100 kDa) or proteins having flexible domains for which structural studies are not otherwise achievable.

### EXPERIMENTAL SECTION

Biochemical isolation of p53. The biochemical extraction procedure of p53 complexes from human cancer cells has been previously described. Briefly, U87MG glioblastoma cells (ATCC) were cultured under standard growth conditions. Cells were harvested from adherent flasks and pelleted by centrifugation. The cells were lysed using the NE-PER kit (Thermo Fisher Scientific), which also served to separate the cytoplasmic and nuclear fractions of the lysed cells. Soluble nuclear fractions (˜1 mg/mL) were collected and incubated with nickel-nitrilotriacetic acid (Ni-NTA) agarose beads (Qiagen) equilibrated in HEPES buffer (20 mM HEPES (pH 7.2), 140 mM NaCl, 2 mM CaCl₂, 2 mM MgCl₂, and 5 mM imidazole) for 1 hour at 4° C. The same buffer was used to elute complexes, supplemented with 60 mM imidazole. Fractions were evaluated using Simply Blue-stained SDS-PAGE gels (Invitrogen, Thermo Fisher Scientific) according to manufacturer's instructions. Western blots were probed with monoclonal antibodies against the p53 NTD (DO-1; Santa Cruz Biotechnology, sc-126).

Cryo-EM sample preparation. For cryo-EM sample preparation, SiN microchips containing integrated microwells or flow channels (Protochips, Inc.) were used.

These microchips were previously used to analyze other protein structures. The frames of the microchips were 2 mm×2 mm in the x- and y-dimension and 0.3 mm in the z-dimension. Arrays of microwells were etched into the imaging windows that can vary in dimensions from 500 μm×200 μm to 500 μm×100 μm. Individual microwells were 10 μm×10 μm in x- and y- and can accommodate a sample thickness of 150 nm in the z-dimension. Alternatively, flow channels etched into the microchips were tested and successfully produced p53 samples in thin layers of vitreous ice. Prior to use, microchips were cleaned by submerging in acetone for 2 minutes, followed by methanol for 2 minutes and allowed to air dry. Cleaned microchips were coated with 25% Ni-NTA-containing lipid monolayers as previously described. Aliquots (2 μL) of different p53 fractions (0.2 mg/mL) in HEPES buffer (20 mM HEPES (pH 7.5), 140 mM NaCl, 2 mM CaCl₂, 2 mM MgCl₂, and 5 mM imidazole) were added to the Ni-NTA-coated microchips and incubated for 2 minutes at room temperature. The microchip samples were then loaded into a FEI Mark III Vitrobot and flash-frozen into liquid ethane. Specimens were placed in the tip of a 626 Gatan specimen holder at −180° C. and transferred to a Talos F200C TEM (ThermoFisher Scientific) for data collection. Protein samples spread evenly over the imaging windows. Attempts to use any holey carbon substrates or patterned gold grids for sample preparation failed to produce p53 particles in the holes of the grid (i.e., empty holes). Samples lacking particles were not used for data collection.

EM data collection and image processing. Frozen hydrated p53 samples were examined using a Talos F200C TEM (ThermoFisher Scientific) operating at 200 kV. Images were collected under low dose conditions (˜5 electrons/Å²/sec; 1-second exposures) using a CETA camera (ThermoFisher Scientific) with a pixel size of 14-μm. The nominal magnification was ˜142,000× and the final sampling at the specimen level was ˜0.98 Å/pixel. The RELION software package was used to analyze images collected from the different biochemical fractions, yielding separate p53 monomer and dimer structures. Within RELION, CTF parameters were estimated using CTFFIND-4.1 integrated into the package. Additional parameters for refinement procedures included spherical aberration, voltage, and amplitude contrast values which were set to 2.7 mm, 200 kV, 0.1 respectively. Particles were manually picked and extracted using a box size of 100 pixels. Particles were extracted using reference-free routines while implementing auto-picking procedures to include ˜8,000 particles for each structure. Images containing drift were not included, therein all selected particles were used in downstream processing steps. Ab initio methods and C1 symmetry were used to generate initial models based on the experimental image data. Initial models were subjected to 3D refinement procedures over 25 iterations for each map. During refinement, C2 symmetry was used for the p53 dimer structure. Final maps contained ˜8000 particles. Resolution values were determined in RELION using the 0.143-FSC criteria, Cref (0.5)), and independently validated globally using the RMEASURE executable.

Molecular modeling and movie production. To interpret the EM maps, a model for full-length p53 was produced using the PHYRE2 Protein Fold Recognition Server. Models were also attempted using Alpha-fold, but the software package failed to produce a full-length model having known features of the p53 structure. The model produced by PHYRE2 was initially fit into the sharpened monomer map using rigid-body refinement procedures in the PHENIX software package. This step provided a coarse-level of model-fitting but required model rebuilding and further rounds of refinement. The ISOLDE package operating in Chimera X was used to perform molecular dynamics/flexible fitting routines on the PHENIX output, correcting for bad angles and contacts to ultimately improve the best model. Statistics for the final model were validated using MolProbity and reported in Table 3. To interpret the p53 dimer structure, two monomer models were fit into the dimer map using the ISOLDE package operating in ChimeraX. No bonds were modified in the dimer fit of the two monomers. The length of the p53 dimer structure was ˜70 Å and the EM map revealed no characteristic density for a double-stranded DNA helix. To produce a molecular framework for the p53 dimer bound to DNA, the DBD domain of the new p53 model was superimposed over the DBD domain of the p53 crystal structure bound to a DNA helix (pdb code, 2AC0). Movies for the dimer and monomer structures were produced using the ChimeraX software package and animations were produced using the Blender package.

### C. REFERENCES

Alden, N. A. et al. Cryo-EM-On-a-Chip: Custom-Designed Substrates for the 3D Analysis of Macromolecules. Small 15, 1900918 (2019).
Bista, M., Freund, S. M. & Fersht, A. R. Domain—domain interactions in full-length p53 and a specific DNA complex probed by methyl NMR spectroscopy. Proc Natl Acad Sci USA 109, 15752 (2012).
Brennan, C. W. et al. The Somatic Genomic Landscape of Glioblastoma. Cell 155, 462-477 (2013).
Brooks, C. L. & Gu, W. p53 regulation by ubiquitin. FEBS Lett 585, 2803-2809 (2011).
Butler, J. S. & Loh, S. N. Structure, Function, and Aggregation of the Zinc-Free Form of the p53 DNA Binding Domain. Biochemistry 42, 2396-2403 (2003).
Glazko, G. V., Koonin, E. V. & Rogozin, I. B. Mutation hotspots in the p53 gene in tumors of different origin: correlation with evolutionary conservation and signs of positive selection. Biochimica et Biophysica Acta (BBA)—Gene Structure and Expression 1679, 95-106 (2004).
Hamard, P.-J. et al. The C terminus of p53 regulates gene expression by multiple mechanisms in a target- and tissue-specific manner in vivo. Genes & Development 27, 1868-1885 (2013).
He, F. et al. Interaction between p53 N terminus and core domain regulates specific and nonspecific DNA binding. Proc Natl Acad Sci USA 116, 8859 (2019).
Joerger, A. C. & Fersht, A. R. The tumor suppressor p53: from structures to drug discovery. Cold Spring Harb Perspect Biol 2, a000919-a000919 (2010).
Karni-Schmidt, O., Lokshin, M. & Prives, C. The Roles of MDM2 and MDMX in Cancer. Annu. Rev. Pathol. Mech. Dis. 11, 617-644 (2016).
Kelley, L. A., Mezulis, S., Yates, C. M., Wass, M. N. & Sternberg, M. J. E. The Phyre2 web portal for protein modeling, prediction and analysis. Nature Protocols 10, 845-858 (2015).
Kitayner, M. et al. Structural Basis of DNA Recognition by p53 Tetramers. Molecular Cell 22, 741-753 (2006).
Landré, V. et al. Regulation of transcriptional activators by DNA-binding domain ubiquitination. Cell Death Differ 24, 903-916 (2017).
Laptenko, O. et al. The p53 C terminus controls site-specific DNA binding and promotes structural changes within the central DNA binding domain. Mol Cell 57, 1034-1046 (2015).

### Li, M., Luo, J., Brooks, C. L. & Gu, W. Acetylation of p53 Inhibits Its Ubiquitination by Mdm2*. Journal of Biological Chemistry 277, 50607-50611 (2002).

Liang, Y. et al. Correcting errors in the BRCA1 warning system. DNA Repair 73, 120-128 (2019).
Liu, X. et al. NAT10 regulates p53 activation through acetylating p53 at K120 and ubiquitinating Mdm2. EMBO Rep 17, 349-366 (2016).
Machida, M. et al. Purification of phosphoproteins by immobilized metal affinity chromatography and its application to phosphoproteome analysis. The FEBS Journal 274, 1576-1587 (2007).
Maria J. Solares et al. Isolation of Disease-relevant p53 for Cryo-Electron Microscopy Analysis. Protocol Exchange (2021) doi:10.21203/rs.3.pex-1294/v1.
McLure, K. G. & Lee, P. W. K. How p53 binds DNA as a tetramer. The EMBO Journal 17, 3342-3350 (1998).
Natan, E. et al. Interaction of the p53 DNA-Binding Domain with Its N-Terminal Extension Modulates the Stability of the p53 Tetramer. Journal of Molecular Biology 409, 358-368 (2011).
Nicholls, C. D., McLure, K. G., Shields, M. A. & Lee, P. W. K. Biogenesis of p53 Involves Cotranslational Dimerization of Monomers and Posttranslational Dimerization of Dimers: IMPLICATIONS ON THE DOMINANT NEGATIVE EFFECT*. Journal of Biological Chemistry 277, 12937-12945 (2002).
Okorokov, A. L., Ponchel, F. & Milner, J. Induced N- and C-terminal cleavage of p53: a core fragment of p53, generated by interaction with damaged DNA, promotes cleavage of the N-terminus of full-length p53, whereas ssDNA induces C-terminal cleavage of p53. EMBO J 16, 6008-6017 (1997).
Olivier, M., Hollstein, M. & Hainaut, P. TP53 mutations in human cancers: origins, consequences, and clinical use. Cold Spring Harb Perspect Biol 2, a001008-a001008 (2010).
Pettersen, E. F. et al. UCSF Chimera—A visualization system for exploratory research and analysis. Journal of Computational Chemistry 25, 1605-1612 (2004).
Sayan, B. S., Sayan, A. E., Knight, R. A., Melino, G. & Cohen, G. M. p53 Is Cleaved by Caspases Generating Fragments Localizing to Mitochondria. Journal of Biological Chemistry 281, 13566-13573 (2006).

Scheres, S. H. W. A Bayesian view on cryo-EM structure determination. J Mol Biol 415, 406-418 (2012).

Solares, M. J. et al. Microchip-Based Structure Determination of Disease-Relevant p53. Anal. Chem. 92, 15558-15564 (2020).
Sullivan, K. D., Galbraith, M. D., Andrysik, Z. & Espinosa, J. M. Mechanisms of transcriptional regulation by p53. Cell Death & Differentiation 25, 133-143 (2018).
Sykes, S. M. et al. Acetylation of the p53 DNA-binding domain regulates apoptosis induction. Mol Cell 24, 841-851 (2006).
Tang, Y., Luo, J., Zhang, W. & Gu, W. Tip60-Dependent Acetylation of p53 Modulates the Decision between Cell-Cycle Arrest and Apoptosis. Molecular Cell 24, 827-839 (2006).
Tang, Y., Zhao, W., Chen, Y., Zhao, Y. & Gu, W. Acetylation is indispensable for p53 activation. Cell 133, 612-626 (2008).
Tchaga, G. S. Affinity Chromatography of Phosphorylated Proteins. in Affinity Chromatography: Methods and Protocols (ed. Zachariou, M.) 285-294 (Humana Press, 2008). doi:10.1007/978-1-59745-582-4_19.
Tidow, H. et al. Quaternary structures of tumor suppressor p53 and a specific p53—DNA complex. Proc Natl Acad Sci USA 104, 12324 (2007).
Vousden, K. H. & Lu, X. Live or let die: the cell's response to p53. Nature Reviews Cancer 2, 594-604 (2002).

### Weinberg, R. L., Veprintsev, D. B. & Fersht, A. R. Cooperative Binding of Tetrameric p53 to DNA. Journal of Molecular Biology 341, 1145-1159 (2004).

Yun, T. et al. Acetylation of p53 Protein at Lysine 120 Up-regulates Apaf-1 Protein and Sensitizes the Mitochondrial Apoptotic Pathway. J Biol Chem 291, 7386-7395 (2016).
Zhang, Y. et al. The p53 Pathway in Glioblastoma. Cancers (Basel) 10, 297 (2018).

### D. SEQUENCES

SEQ ID NO: 1
p53 amino acid sequence
MEEPQSDPSVEPPLSQETFSDLWKLLPENNVLSPLPSQAMDDLMLSPDDI
EQWFTEDPGPDEAPRMPEAAPPVAPAPAAPTPAAPAPAPSWPLSSSVPSQ
KTYQGSYGFRLGFLHSGTAKSVTCTYSPALNKMFCQLAKTCPVQLWVDST
PPPGTRVRAMAIYKQSQHMTEVVRRCPHHERCSDSDGLAPPQHLIRVEGN
LRVEYLDDRNTFRHSVVVPYEPPEVGSDCTTIHYNYMCNSSCMGGMNRRP
ILTIITLEDSSGNLLGRNSFEVRVCACPGRDRRTEEENLRKKGEPHHELP
PGSTKRALPNNTSSSPQPKKKPLDGEYFTLQIRGRERFEMFRELNEALEL
KDAQAGKEPGGSRAHSSHLKSKKGOSTSRHKKLMFKTEGPDSD

What is claimed is:

1. A method of resolving a structure of a full-length protein, said method comprising
isolating the protein of interest,
applying the protein to a microchip, and
creating an electron microscopy (EM) map thereby resolving the structure of the full-length protein.

2. The method of claim 1, wherein the microchip comprises silicon nitride (SiN).

3. The method of claim 1, wherein the microchip comprises flat surfaces or microwells are coated with nickel-nitrilotriacetic (Ni-NTA).

4. The method of claim 1, wherein the microchip comprises microwells that are about 100 nm to about 200 nm in size.

5. The method of claim 1, wherein the microchip further comprises a carbon grid.

6. The method of claim 1, wherein the protein structure is resolved in a liquid solution.

7. The method of claim 1, wherein the method further comprises performing a complementary biochemical on-chip assay for downstream characterization.

8. The method of claim 7, wherein the downstream characterization comprises mass spectrometry analysis, SDS-PAGE analysis, surface plasmon resonance analysis, enzyme-linked immunoassays, lateral-flow cassette analysis, on-chip microfluidic analysis, atomic force microscopy, scanning transmission EM (STEM), and/or a chemical mapping analysis.

9. The method of claim 1, wherein the full-length protein comprises a multimeric structure comprising more than one monomer.

10. The method of claim 1, wherein the EM map is created by
calculating the multimeric structure of the protein and modeling the molecular structure of the protein;
constructing a full-length protein model using a protein prediction software; and
fitting the full-length protein model into an EM map using rigid-body refinement.

11. A method of identifying a therapeutic target, said method comprising
isolating a protein of interest;
applying the protein to a microchip;
creating an electron microscopy (EM) map; wherein the EM map is created by calculating multimeric structures of the protein and modeling the molecular structure of the protein;
constructing a full-length protein model using a protein prediction software;
fitting the full-length protein model into an EM map using rigid-body refinement; and
assaying individual residues in a DNA-bound model for mutations at residues that do not directly interact with the helical backbone, mutations that effect post translational modification sites, and/or mutations at residues that contact the helical backbone;
wherein an identified mutation comprises a therapeutic target.

12. The method of claim 11, wherein the microchip comprises silicon nitride (SiN).

13. The method of claim 11, wherein the microchip comprises flat surfaces or microwells are coated with nickel-nitrilotriacetic (Ni-NTA).

14. The method of claim 11, wherein the microchip comprises microwells that are about 100 nm to about 200 nm in size.

15. The method of claim 11, wherein the microchip further comprises a carbon grid.

16. The method of claim 11, wherein the protein structure is resolved in a liquid solution.

17. The method of claim 11, wherein the method further comprises performing a complementary biochemical on-chip assay for downstream characterization.

18. The method of claim 17, wherein the downstream characterization comprises mass spectrometry analysis, SDS-PAGE analysis, surface plasmon resonance analysis, enzyme-linked immunoassays, lateral-flow cassette analysis, on-chip microfluidic analysis, atomic force microscopy, scanning transmission EM (STEM), and/or a chemical mapping analysis.

19. The method of claim 11, wherein the protein comprises a multimeric structure comprising more than one monomer.

20. The method of claim 19, wherein the protein comprises a dimeric structure.
